(19) United States
(12) Patent Application Publication
(10) Pub. No.: US 2013/0110472 A1
(43) Pub. Date: May 2, 2013

(54) METHOD AND APPARATUS FOR GENERATING A GEOMETRIC LAYOUT OF A TRAFFIC INTERSECTION

(71) Applicants: Steven Chi Kit Chan, Richmond (CA); Shiying Zhang, Richmond (CA); Christian Grant Milne, New Westminster (CA); Milton Santano Elias Carrasco, Richmond (CA); Daniel Akwera Shihundu, Richmond (CA)

(72) Inventors: Steven Chi Kit Chan, Richmond (CA); Shiying Zhang, Richmond (CA); Christian Grant Milne, New Westminster (CA); Milton Santano Elias Carrasco, Richmond (CA); Daniel Akwera Shihundu, Richmond (CA)

(73) Assignee: Transoft Solutions ,Inc., Richmond ,BC (CA)

(21) Appl. No.: 13/805,635

(22) PCT Filed: Jun. 22, 2011
(86) PCT No.: PCT/CA2011/000753

§ 371 Date: Dec. 19, 2012

Related U.S. Application Data
(60) Provisional application No. 61/357,192, filed on Jun. 22, 2010.
(60) Provisional application No. 61/421,685, filed on Dec. 10, 2010.

(51) Int. Cl. G06F 17/50

(52) U.S. Cl. CPC G06F 17/5004
USPC 703/1

(57) ABSTRACT

A method and apparatus for generating a geometric layout of a traffic intersection is disclosed. The method involves receiving intersection capacity data, where receiving includes receiving an identification of a number of intersection legs associated with the traffic intersection, receiving a lane designation designating a plurality of lanes for accommodating permitted vehicle movements between the intersection legs, each lane having at least one associated permitted vehicle movement, and receiving lane width dimensions for accommodating an expected vehicular traffic volume associated with permitted vehicle movements on each of the plurality of lanes. The method also involves generating a geometric layout of the traffic intersection by receiving orientation data defining respective orientations of each of the intersection legs. The method further involves receiving intersection design criteria for designing the traffic intersection, for each intersection leg, combining the lane width dimensions and the intersection design criteria to determine extents of a roadway segment corresponding to the intersection leg, applying the intersection design criteria to generate corner geometry connecting between the roadway segments, and generating display signals for causing the geometric layout of the intersection to be displayed on a computer display.

### BACKGROUND OF THE INVENTION

1. Field of Invention

This invention relates generally to traffic intersections and more particularly to generating a geometric layout of an intersection.

2. Description of Related Art

Traffic intersection design commonly involves two generally distinct activities. Firstly, a capacity analysis of the intersection may be performed to determine vehicle flow through the intersection. The capacity analysis may be based on a traffic count of vehicular flow along existing roadway and may include a prediction of expected changes to the flows over time. Capacity analysis generally results in a specification of a number of lanes, permitted movements along the lanes and minimum lane widths for accommodating the expected traffic flows. The capacity analysis may further provide for channelization of traffic flows, lane flaring, medians between lanes etc. While the capacity data prescribes many aspects of the intersection, the capacity data at best only provides sufficient information for producing a schematic representation of the intersection.

Accordingly, the data produced by a capacity analysis system generally forms the input to a subsequent geometric design process, in which the physical geometry of the roadways and transitions between roadways is generated. The geometric design process conforms the schematic intersection that is generated in accordance with the capacity data to the real world and enables preparation of a set of plans for the construction of a physical intersection. During the geometric design process constraints may be encountered that necessitate changes to the intersection that require revision of the capacity analysis and generation of new capacity data. Since the two processes are often performed by different people with different sets of skills, there may be a need for several design iterations to reach a satisfactory geometric layout of an intersection, resulting in a process that may become tedious and time consuming.

There remains a need for improved methods for producing geometric representations of traffic intersections.

### SUMMARY OF THE INVENTION

In accordance with one aspect of the invention there is provided a method for generating a geometric layout of a traffic intersection. The method involves receiving intersection capacity data, where receiving includes receiving an identification of a number of intersection legs associated with the traffic intersection, receiving a lane designation designating a plurality of lanes for accommodating permitted vehicle movements between the intersection legs, each lane having at least one associated permitted vehicle movement, and receiving lane width dimensions for accommodating an expected vehicular traffic volume associated with permitted vehicle movements on each of the plurality of lanes. The method also involves generating a geometric layout of the traffic intersection by receiving orientation data defining respective orientations of each of the intersection legs. The method further involves receiving intersection design criteria for designing the traffic intersection, for each intersection leg, combining the lane width dimensions and the intersection design criteria to determine extents of a roadway segment corresponding to the intersection leg, applying the intersection design criteria to generate corner geometry connecting between the roadway segments, and generating display signals for causing the geometric layout of the intersection to be displayed on a computer display.

The method may involve generating the intersection capacity data using an intersection capacity analysis system.

Receiving the intersection capacity data may involve receiving intersection capacity data at an interface of an intersection design system.

Receiving the intersection capacity data may involve receiving a data file having fields encoded with values defining the intersection leg identification, lane designation, and lane width dimensions.

Receiving the data file may involve receiving an extensible markup language (XML) data file.

Receiving the lane designation may involve receiving data defining at least one of an approach lane and an exit lane for each of the at least two roadways.

Receiving the lane designation may involve receiving at least one turn designation associated with each of the approach lanes and the exit lanes, the turn designation defining the permitted vehicle movements along each of the lanes.

Receiving the intersection capacity data may further involve receiving speed data associated with each of the permitted vehicle movements, and applying the intersection design criteria to generate the corner geometry may involve using a defined turning path criteria of the design criteria to generate a corner geometry for safely accommodating the vehicle speed along the lane.

The method may involve generating an updated geometric layout in response to receiving operator input defining a change to the intersection, generating updated intersection capacity data including revised data corresponding to the change, and causing the interface to transmit the updated intersection capacity data back to the capacity analysis system.

Receiving the intersection design criteria may involve receiving an operator selection of an industry standard intersection design guideline for designing the traffic intersection.

Receiving the intersection design criteria may involve receiving a designation of a design vehicle for designing the traffic intersection and applying the intersection design criteria to generate corner geometry may involve identifying at least one permitted vehicle movement that defines the corner geometry connecting between the roadway segments, generating a turning path of the design vehicle along the identified permitted vehicle movement, generating first vehicle extent locations associated with passage of the design vehicle along the at least one turning path, and generating an outer edge of the intersection area, the outer edge being generally aligned with selected ones of the first vehicle extent locations.

Receiving the orientation data may involve receiving at least two reference lines defining respective orientations of the intersection legs.

Receiving the at least two reference lines may involve receiving a reference line extending in a direction aligned with an intended direction of traffic movement along a corresponding intersection leg and combining the lane width dimensions and the intersection design criteria may involve offsetting the lane width dimensions from the reference line to determine the extents of the a roadway segment corresponding to the intersection leg.

The method may involve offsetting the lane width dimensions to accommodate at least one of a median between lanes, a clearance allowance between lanes, a clearance allowance between an edge of the roadway section and a curb defining a physical extent of the roadway, or a storage bay associated with a lane designated to permit turning of a vehicle.

Applying the intersection design criteria to generate the corner geometry may involve generating a swept path of a design vehicle between the roadway segments, using the swept path to generate the corner geometry.

Using the swept path to generate the corner geometry may involve generating a curve that generally conforms to the swept path.

The curve may involve one of a simple curve, a 2-centered compound curve, and a 3-centered compound curve.

In accordance with another aspect of the invention there is provided an apparatus for displaying a geometric layout of a traffic intersection. The apparatus includes a processor circuit operably configured to receive intersection capacity data including an identification of a number of intersection legs associated with the traffic intersection, a lane designation designating a plurality of lanes for accommodating permitted vehicle movements between the intersection legs, each lane having at least one associated permitted vehicle movement, and lane width dimensions for accommodating an expected vehicular traffic volume associated with permitted vehicle movements on each of the plurality of lanes. The processor circuit is also operably configured to generate a geometric layout of the traffic intersection by receiving orientation data defining respective orientations of each of the intersection legs. The processor circuit is also operably configured to receive intersection design criteria for designing the traffic intersection The processor circuit is further operably configured to, for each intersection leg, combine the lane width dimensions and the intersection design criteria to determine extents of a roadway segment corresponding to the intersection leg, apply the intersection design criteria to generate corner geometry connecting between the roadway segments, and to generate display signals for causing the geometric layout of the intersection to be displayed on a computer display.

The processor circuit may be operably configured to generate the intersection capacity data using an intersection capacity analysis system.

The processor circuit may be operably configured to generate the intersection capacity data for each permitted movement by receiving a designation of an expected proportion of different vehicles classified in accordance with vehicle size, receiving an expected flow of vehicles of each classification as a function of time, and generating a lane width dimensions sufficient to accommodate the flow of vehicles.

The apparatus may include an intersection design system having an interface operably configured to receive the intersection capacity data.

The processor circuit may be operably configured to receive the intersection capacity data by receiving a data file having fields encoded with values defining the intersection leg identification, lane designation, and lane width dimensions.

The data file may include receiving an extensible markup language (XML) data file.

The lane designation may include data defining at least one of an approach lane and an exit lane for each of the at least two roadways.

The lane designation may include at least one turn designation associated with each of the approach lanes and the exit lanes, the turn designation defining the permitted vehicle movements along each of the lanes.

The intersection capacity data may include speed data associated with each of the permitted vehicle movements, and the processor circuit may be operably configured to apply the intersection design criteria to generate the corner geometry by using a defined turning path criteria of the design criteria to generate a corner geometry for safely accommodating the vehicle speed along the lane.

The processor circuit may be operably configured to generate the intersection capacity data using an intersection capacity analysis system, generate an updated geometric layout in response to receiving operator input defining a change to the intersection, generate updated intersection capacity data including revised data corresponding to the change, and cause the interface to transmit the updated intersection capacity data back to the capacity analysis system.

The processor circuit may be operably configured to receive the intersection design criteria by receiving an operator selection of a traffic intersection template for designing the traffic intersection.

The processor circuit may be operably configured to receive the intersection design criteria by receiving an operator selection of an industry standard intersection design guideline for designing the traffic intersection.

The processor circuit may be operably configured to receive the intersection design criteria by receiving data defining line-of-sight criteria for the traffic intersection.

The processor circuit may be operably configured to receive the intersection design criteria by receiving a designation of a design vehicle for designing the traffic intersection and to apply the intersection design criteria to generate corner geometry by identifying at least one permitted vehicle movement that defines the corner geometry connecting between the roadway segments, generating a turning path of the design vehicle along the identified permitted vehicle movement, generating first vehicle extent locations associated with passage of the design vehicle along the at least one turning path, and generating an outer edge of the intersection area, the outer edge being generally aligned with selected ones of the first vehicle extent locations.

The processor circuit may be operably configured to receive the orientation data by receiving at least two reference lines defining respective orientations of the intersection legs.

The processor circuit may be operably configured to receive the at least two reference lines by receiving a reference line extending in a direction aligned with an intended direction of traffic movement along a corresponding intersection leg and to combine the lane width dimensions and the intersection design criteria by offsetting the lane width dimensions from the reference line to determine the extents of the a roadway segment corresponding to the intersection leg.

The processor circuit may be operably configured to offset the lane width dimensions to accommodate at least one of a median between lanes, a clearance allowance between lanes, a clearance allowance between an edge of the roadway section and a curb defining a physical extent of the roadway, and or a storage bay associated with a lane designated to permit turning of a vehicle.

The processor circuit may be operably configured to apply the intersection design criteria to generate the corner geometry by generating a swept path of a design between the roadway segments, and using the swept path to generate the corner geometry.

The processor circuit may be operably configured to use the swept path to generate the corner geometry by generating a curve that generally conforms to the swept path.

The curve may include one of a simple curve, a 2-centered compound curve, and a 3-centered compound curve.

In accordance with another aspect of the invention there is provided a computer readable medium encoded with codes for directing a processor circuit to display a geometric layout of a traffic intersection. The codes direct the processor circuit to receive intersection capacity data including an identification of a number of intersection legs associated with the traffic intersection, and a lane designation designating a plurality of lanes for accommodating permitted vehicle movements between the intersection legs, each lane having at least one associated permitted vehicle movement. The codes also direct the processor circuit to receive intersection capacity data including lane width dimensions for accommodating an expected vehicular traffic volume associated with permitted vehicle movements on each of the plurality of lanes. The codes further direct the processor circuit to generate a geometric layout of the traffic intersection by receiving orientation data defining respective orientations of each of the intersection legs, receiving intersection design criteria for designing the traffic intersection, and for each intersection leg, combining the lane width dimensions and the intersection design criteria to determine extents of a roadway segment corresponding to the intersection leg. The codes also direct the processor circuit to apply the intersection design criteria to generate corner geometry connecting between the roadway segments, and to generate display signals for causing the geometric layout of the intersection to be displayed on a computer display.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention,

FIG. 1 is a block diagram of a system for displaying a geometric layout of a traffic intersection including an intersection design apparatus according to a first embodiment of the invention;

FIG. 2 is a flowchart of a process for generating the geometric layout of the intersection executed by the intersection design apparatus shown in FIG. 1;

FIG. 3 is a table listing various intersection capacity data types;

FIG. 4 is a table listing exemplary intersection capacity data for an unsignalized intersection;

FIG. 5 is a schematic intersection layout corresponding to the intersection capacity data listed in the table of FIG. 4;

FIG. 6 is a representation of orientation data received by the intersection design apparatus of FIG. 1;

FIG. 7 is a is a table listing exemplary intersection design criteria;

FIG. 8 is a partial geometric layout of the intersection defined by the data listed in the table in FIG. 4 and oriented as defined by the orientation data shown in FIG. 6;

FIG. 9 is a completed geometric layout of the intersection shown in FIG. 8;

FIG. 10 is a block diagram of a processor circuit for implementing the system shown in FIG. 1;

FIG. 11 is a flowchart depicting blocks of code for directing the processor circuit shown in FIG. 10 to carry out a process for generating and receiving capacity data;

FIGS. 12A and 12B are listings of portions of a representative XML capacity data file generated by the process shown in FIG. 11;

FIG. 13 is a screenshot of an operator interface representing a schematic layout of the intersection displayed by the processor circuit shown in FIG. 10;

FIG. 14 is a screenshot of an operator interface representing a geometric layout of the intersection displayed by the processor circuit shown in FIG. 10;

FIG. 15 is a screenshot of an operator interface for receiving operator input of corner geometry design parameters;

FIG. 16 is a screenshot of an operator interface for receiving operator input of design movement parameters;

FIG. 17 is a side view of a plurality of exemplary design vehicles;

FIG. 18 is a table of design vehicle parameters for the design vehicles shown in FIG. 17;

FIG. 19 is a screenshot of an operator interface for entering or editing design vehicle parameters displayed by the processor circuit shown in FIG. 10;

FIG. 20 is a top view of the design vehicles shown in FIG. 17;

FIGS. 21A and 21B are block diagrams of a process executed by the processor circuit shown in FIG. 10 for generating corner geometry;

FIG. 22 is a detailed plan view of a portion of the intersection shown in FIG. 9;

FIG. 23 is a schematic view of a transition portion of a turning path of the intersection shown in FIG. 22;

FIG. 24 is a block diagram of a process executed by the processor circuit shown in FIG. 10 for generating an outer edge of the intersection shown in FIG. 22; and

FIG. 25 is an updated screenshot of the operator interface shown in FIG. 14.

### DETAILED DESCRIPTION

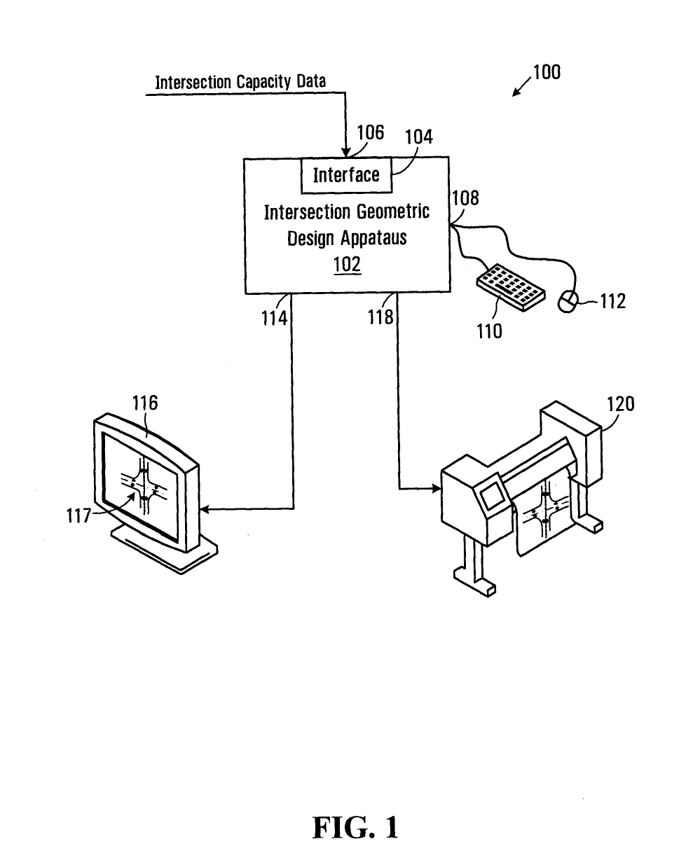

Referring to FIG. 1, a system for displaying a geometric layout of a traffic intersection according to a first embodiment of the invention is shown generally at 100. The system 100 includes an apparatus 102 for generating a geometric design of a traffic intersection. The apparatus 102 includes an interface 104 having an input 106 for receiving intersection capacity data. The apparatus 102 also includes an input 108 for receiving operator input from user input devices such as a keyboard 110 and a pointing device 112. The apparatus 102 further includes an output 114 for generating display signals for causing the geometric layout of the intersection to be displayed on a display 116. The apparatus 102 also includes an output 118 for generating signals for driving a printer 120 to print a hardcopy representation of the geometric layout of the intersection.

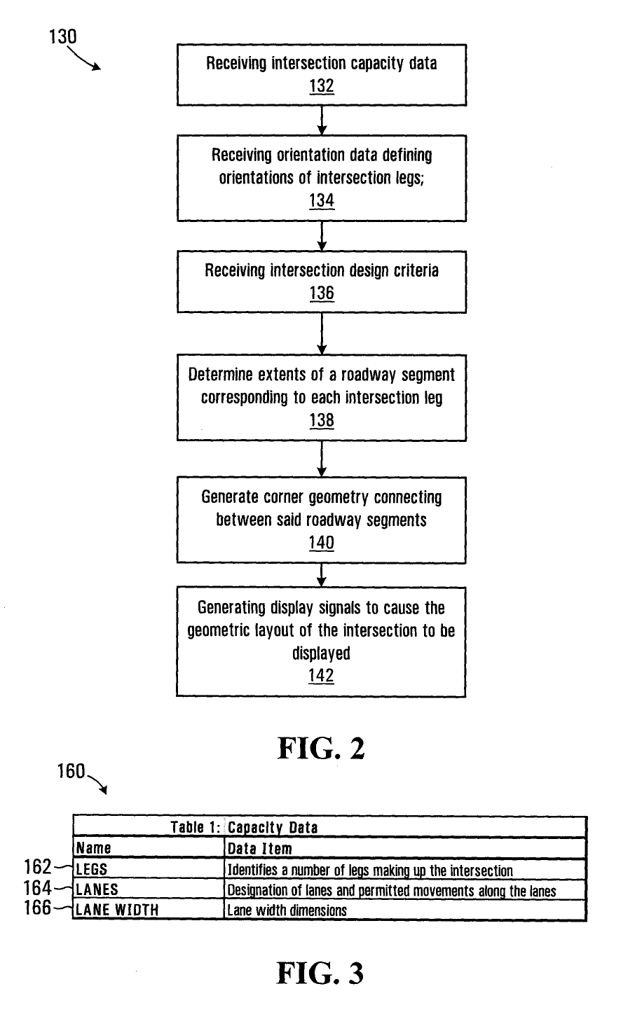

Referring to FIG. 2, a process executed by the apparatus 102 for generating the geometric layout of the intersection is shown generally at 130. The process begins at block 132 with receiving of intersection capacity data at the input 106 of the interface 104. In one embodiment the interface 104 may be a network interface and the intersection capacity data may be received over a network such as a local area network or a wide area network. In other embodiments, the intersection capacity data may be received as a data file that is readable by the apparatus 102. One example of such a data file is an extensible markup language (XML) file.

Referring to FIG. 3, a listing of types of intersection capacity data that may be received at the interface 104 is shown generally at 160 in Table 1. The intersection capacity data 160 includes a LEGS data field 162 including data identifying a number of legs making up the intersection. A leg is a segment of roadway connecting to the intersection. A typical intersection will generally have at least three legs, of which at least one leg is an approach leg used by vehicles approaching the intersection and at least one leg is a departure leg used by vehicles leaving the intersection. The intersection capacity data 160 also includes a LANES data field 164 including data identifying one or more lanes associated with each leg. A lane is a portion of the roadway for the movement of a single line of vehicles and accommodates at least one permitted movement through the intersection such as a left turn or right turn for example, however some lanes may accommodate more than a single permitted movement. The intersection capacity data 160 further includes a LANE WIDTH data field 166 including a width dimension of each of the lanes identified in the LANES data field 164.

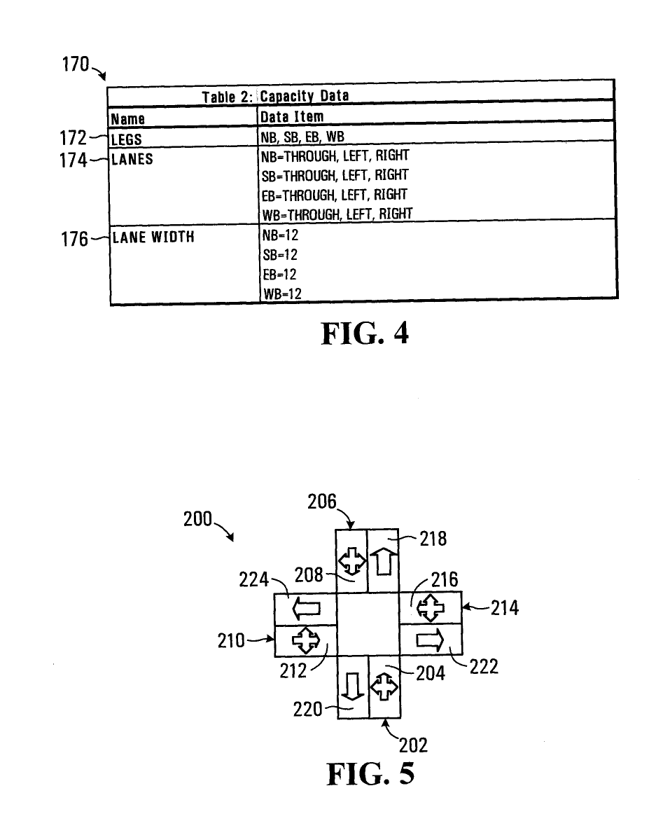

Referring to FIG. 4, an exemplary intersection capacity data table including values for a simple unsignalized intersection is shown at 170 in Table 2. The LEGS data 172 includes an identification of four legs including a northbound leg (NB), southbound leg (SB), eastbound leg (EB), and a westbound leg (WB). In general the directions (NB, SB, EB, and WB) provided by existing capacity analysis systems only provide general orientations of the legs of the intersection and do not directly define a specific physical alignment or orientation of the legs. In the example shown, the LANES data 174 in Table 2 identifies each leg as having a respective single lane that accommodates left turning vehicles, through traffic, and right turning vehicles. In other embodiments the LANES data 174 may include a definition of more than one lane for each direction and, the defined lanes may be limited so as to permit only certain movements, such as a left turn only lane, for example. Finally in the example shown in Table 2, the LANE WIDTH data 176 defines a lane width for each of the lanes identified in 174 as having a width of 12 feet (in this case the width units are in feet).

The intersection capacity data 170 shown in Table 2 may be generated using an intersection capacity analysis system such as the Highway Capacity Software product (HCS+™) produced by the University of Florida McTrans Center (McTrans). Several other commercially available software products for generating intersection capacity data are also available, and many of these products are capable of providing intersection capacity data in the form of an export data file for receipt at the input 106 of the interface 104. The capacity data 170 in Table 2 may thus be received as a computer readable data file, in which case the interface 104 would be implemented as a file interface. Alternatively, the capacity data 170 may be received as a computer readable signal and the interface 104 may be implemented as a network interface, such as an Ethernet network interface, for example.

A schematic intersection layout in accordance with the capacity data 170 in Table 2 is shown generally at 200 in FIG. 5. Referring to FIG. 5, the layout 200 includes schematic representations of a northbound leg 202 having an approach lane 204, a southbound leg 206 having an approach lane 208, an eastbound leg 210 having an approach lane 212, and a westbound leg 214 having an approach lane 216. Each of the approach lanes 204, 208 212 and 216 have corresponding exit or departure lanes 218, 220, 222, and 224. The schematic layout 200, which is generated from the capacity data 170 in Table 2 thus provides no specific geometric layout details and is not generally to scale. The layout 200 represents the intersection oriented in cardinal directions defined by the LEGS data field 172, with lane extents being schematically represented by vertical and/or horizontal lines. Many existing capacity analysis systems are capable of producing schematic intersection layouts similar to the layout 200.

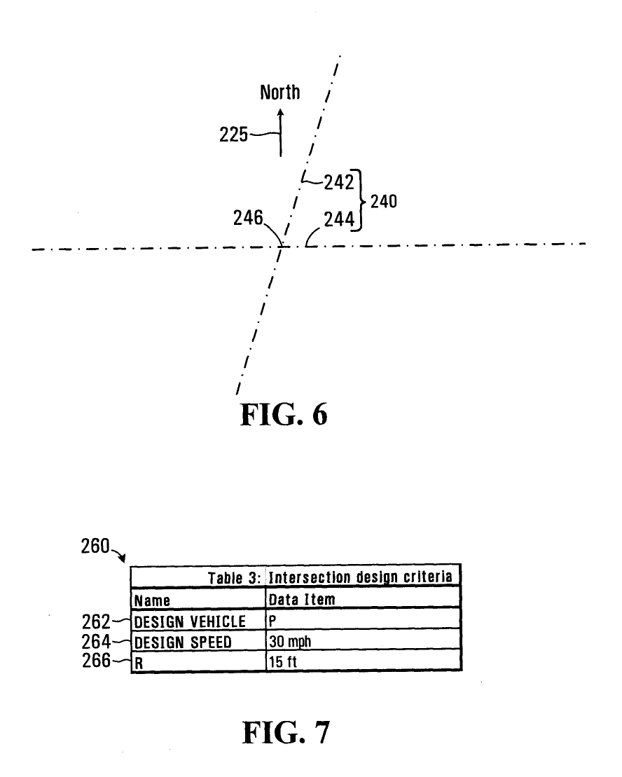

Referring back to FIG. 2, the process 130 then continues at block 134 with the receiving of orientation data defining the relative orientation between the legs of the intersection. Referring to FIG. 6, in the embodiment shown the orientation between legs is represented by reference lines 240. In this embodiment the reference lines 240 include a first reference line 242 and a second reference line 244, which intersect at a point 246. The first reference line 242 provides an orientation for the northbound leg 202 and the southbound leg 206 (shown schematically in FIG. 5), while the second reference line 244 provides an orientation for the eastbound leg 210 and the westbound leg 214. The reference lines 240 shown in FIG. 6 may be displayed on the display 116 (shown in FIG. 1) and may be oriented in response to operator input received at the input 108 of the intersection design apparatus 102. In the embodiment shown, the line 242 in FIG. 6 is oriented at an angle with respect to a northerly cardinal direction indicated by the arrow 225. However in other embodiments the cardinal direction 225 may not be specified and the reference lines 240 may indicate only a relative orientation for the legs 202-206 and the legs 210-214 of the intersection.

Referring back to FIG. 2, the process 130 then continues at block 136 with receiving of intersection design criteria for the geometric layout of the intersection. Geometric layout involves the design of the physical dimensions of an intersection and standards that should be applied in establishing the geometric layout are generally defined by the design criteria. In North America the American Association of State Highway and Transportation Officials (AASHTO) sets forth a number of design guidelines that may be used to generate a geometric layout of an intersection. Other jurisdictions may apply different guidelines.

Referring to FIG. 7, a listing of some exemplary intersection design criteria are shown at 260 in Table 3. The intersection design criteria 260 include an identification 262 of a design vehicle that should be considered when designing the intersection. In this embodiment the design vehicle is designated as a passenger vehicle “P”, which may be used in designing local streets. For major collector roadways a single unit truck would be a more appropriate design vehicle, while for major arterial roadways a tractor-trailer truck would generally be used as the design vehicle. The selection of the design vehicle may be prescribed by AASHTO or another standards body. In general, different design vehicles will have a turning characteristic when executing a turn between legs of the intersection.

The intersection design criteria 260 also include a design speed 264 for the design vehicle 262. The design speed 264 may be prescribed by a standards body or may be related to an intended posted speed limit on roadways that are to connect to the intersection. In this embodiment, the design criteria 260 further includes a minimum turning radius 266 for the design vehicle 262 traveling at the design speed 264. The minimum turning radius R may be read from a table of values prescribed by a standards body or may be calculated for the selected or prescribed design vehicle 262 on the basis of the design speed 264. In one embodiment the apparatus 102 may include a database of design vehicles and associated parameters, and the selection of the design vehicle 262 and design speed 264 may be received from an operator at the input 108 of the intersection design apparatus 102 (shown in FIG. 1).

In other embodiments, the intersection design criteria may additionally provide specific criteria for corner geometry connecting between roadway segments, such as radii guidelines for a circular arc or a 3-centered compound curve defining the corner geometry.

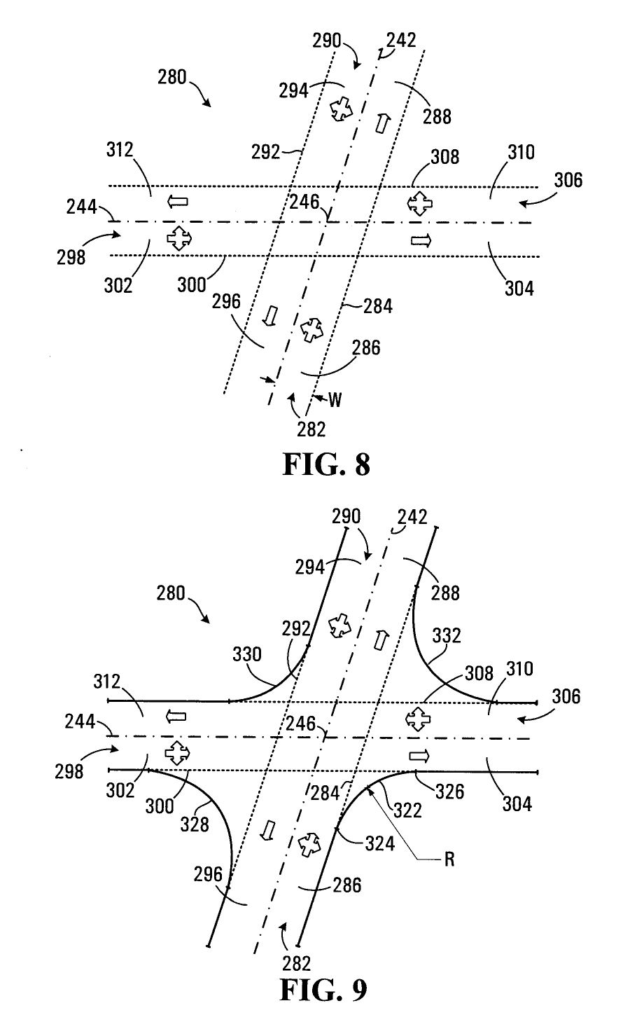

Referring back to FIG. 2, the process 130 then continues at block 138, where an extent of a roadway segment corresponding to each intersection leg is determined. An initial geometric layout of the intersection defined by the data in Table 2 and oriented along the reference lines 242 and 240 is shown generally at 280 in FIG. 8.

Referring to FIG. 8, the geometric layout 280 includes a generally northbound roadway segment 282 having an extent defined between the first reference line 242 and a line segment 284. In this embodiment, the line segment 284 is parallel to the first reference line 242 and is offset by the lane width W of the northbound lane (NB=12 feet) taken from Table 2. The roadway segment 282 defines roadway portions 286 and 288 that correspond to both the approach lane 204 and the exit lane 218 shown schematically in FIG. 5. The geometric layout 280 also includes a generally southbound roadway segment 290 having an extent defined between the first reference line 242 and a line segment 292 offset by the lane width W of the southbound lane (SB=12) taken from Table 2. The roadway segment 290 defines roadway portions 294 and 296 that correspond to both the approach lane 208 and the exit lane 220 shown schematically in FIG. 5. The geometric layout 280 of the intersection is for a North American road system, where vehicles drive on the right hand side of the road. Clearly, the intersection layout would change for countries such as the United Kingdom or South Africa, where vehicles drive on the left hand side of the road.

Similarly, an eastbound roadway segment 298 has an extent defined between the second reference line 244 and a line segment 300, which defines roadway portions 302 and 304 that correspond to both the approach lane 216 and the exit lane 222 shown schematically in FIG. 5. Finally, a westbound roadway segment 306 has an extent defined between the second reference line 244 and a line segment 308, which defines roadway portions 310 and 312 that correspond to both the approach lane 216 and the exit lane 224 shown schematically in FIG. 5.

In some embodiments a further offset allowance may be added to the widths 176 of the lanes 288 and 290 to provide additional clearance for vehicles using the intersection. Offset allowances, if implemented, may be included in the intersection design criteria received at block 136 or may be received as operator input at the input 108 of the intersection design apparatus 102 (shown in FIG. 1). The extents defined by the line segments 284, 292, 300, and 308 may represent an edge of a paved area of the roadway segment, a curb line, or other boundary defining the roadway segment.

In the embodiment shown in FIG. 8, roadways 282 and 290 have a common alignment along the first reference line 242 and the roadways 298 and 306 have a common alignment along the second reference line 244. However, in other embodiments these roadways may not be commonly aligned, in which case the applicable reference line (i.e. 242 or 244) would comprise a pair of reference lines extending outwardly from the intersection point 246, which are disposed at an angle to each other. While the reference lines 242 and 244 in FIG. 6 are shown as straight lines, in other embodiments either or both of the reference lines may be a curved line or polyline indicating a desired alignment of a curved roadway portion. Furthermore, in this embodiment, the lanes 288 and 290 of the northbound roadway segment 282 have a uniform width W (i.e. 12 ft plus any offset allowance), but in other embodiments the lanes may be different widths or may be tapered to accommodate particular traffic flows to or from the intersection.

Referring back to FIG. 2, the process 130 then continues at block 140, with generation of the corner geometry connecting between the roadway segments. In the schematic layout 200 shown in FIG. 5, the transition between the legs 202, 206, 210, and 214 is represented schematically as a right angle corner. In practice, traffic intersections have curved transitions between legs that provide for turning movements between the roadway segments, such as a right turn between the segments 282 and 298 in FIG. 8.

Referring to FIG. 9, in one embodiment, the minimum turning radius 266 (R) from the intersection design criteria 260 in Table 3 is used to construct an arc 322 of radius R that is tangent to both the line segment 284 at point 324 and the line segment 300 at 326. The arc 322 defines the corner geometry for the transition between the approach 286 and exit 304. Similarly a transition 328 between the approach 302 and the exit 296, a transition 330 between the approach 294 and the exit 312, and a transition 332 between the approach 310 and the exit 288 may be similarly constructed from a simple arc of radius R. Alternatively, more complex transitions such as a 2-centered or 3-centered compound curve may be used to define the corner geometry between the respective approaches and exits: Alternatively transitions between the roadways may be constructed on the basis of a swept path of the design vehicle as described later herein.

Referring back to FIG. 2, the process 130 then continues at block 142, with generation of display signals for driving the display 116 (shown in FIG. 1). The display signals are produced at the output 114 of the intersection design apparatus 102 and cause the display 116 to display a representation 117 of the geometric layout 280 of the intersection. The intersection design apparatus 102 may further cause printer control signals to be generated at the output 118 for causing a hard copy of the geometric layout to be produced by the printer 120. The hardcopy may be an intersection plan, suitable for use during construction of the intersection, for example.

Advantageously, the process 130 when implemented on the system 100 is able to transform the schematic layout 200 shown in FIG. 5, which lacks representation of most geometric aspects of the intersection, into the geometric layout 280 shown in FIG. 8. The geometric layout 280 represents a physical layout of the intersection, and defines physical features of the intersection that are not present in the schematic layout of FIG. 5. In one embodiment, the interface 104 may be configured for data transfer back to a capacity analysis system, such that changes to the geometric layout of the intersection may be communicated to the capacity analysis system to permit further analysis and modification of the capacity data.

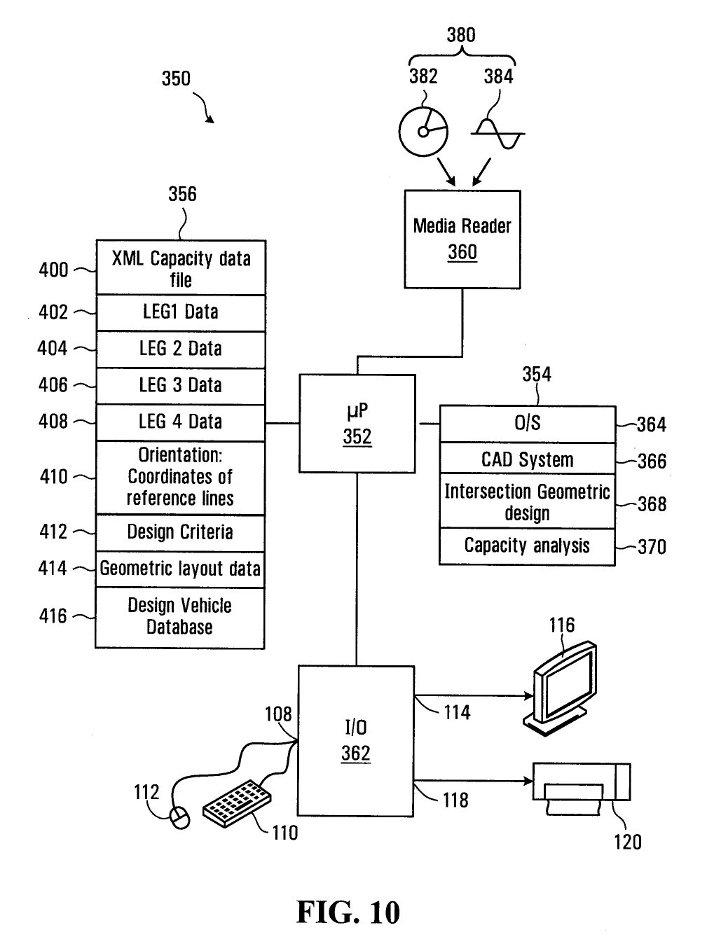

Referring to FIG. 10, a processor circuit for implementing the intersection design system 100 (shown in FIG. 1) is shown generally at 350.

The processor circuit 350 includes a microprocessor 352, a program memory 354, a variable memory 356, a media reader 360, and an input output port (I/O) 362, all of which are in communication with the microprocessor 352.

Program codes for directing the microprocessor 352 to carry out various functions are stored in the program memory 354, which may be implemented as a random access memory (RAM) and/or a hard disk drive (HDD) or other non-volatile storage such as flash memory, or a combination thereof. The program memory 354 includes a first block of program codes 364 for directing the microprocessor 352 to perform operating system functions and a second block of program codes 366 for directing the microprocessor 352 to perform CAD system functions. The program memory 354 also includes a third block of program codes 368 for interacting with the CAD system functions to implement the geometric design apparatus 102 shown in FIG. 1.

The CAD system may be provided by causing a computer to execute CAD system software such as the AutoCAD® software application available from Autodesk Inc. of San Rafael, Calif., USA. AutoCAD provides drawing elements such as lines, polylines, circles, arcs, and other complex elements. Customization of AutoCAD is provided through ObjectARX (AutoCAD Runtime Extension), which is an application programming interface (API) that permits access to a class-based model of AutoCAD drawing elements. Customization code may be written in a programming language such as C++, which may be compiled to provide the codes 368 for implementing the intersection geometric design functions. Other CAD systems, such as MicroStation sold by Bentley Systems Inc. of Exton, Pa., USA, provide similar CAD functionality and interfaces for customization. Advantageously, using existing CAD software applications to provide standard CAD functionality allows operators to produce drawing files representing the traffic intersection using a familiar software application.

The program memory 354 also includes a fourth block of program codes 370 for directing the microprocessor 352 to perform capacity analysis functions. In one embodiment the capacity analysis functions may be provided by the HCS+ capacity analysis product.

The media reader 360 facilitates loading program codes into the program memory 354 from a computer readable medium 380, such as a CD ROM disk 382, or a computer readable signal 384, such as may be received over a network such as the internet, for example.

The I/O 362 includes the input 108 for receiving operator input signals from the keyboard 110 and the pointing device 112. The pointing device may be a computer mouse, trackball, or digitizing tablet, or other device operable o produce pointer movement signals. The I/O 362 further includes the output 114 for generating display signals for driving the display 116 and the output 118 for producing printer control signals for driving the printer 120.

The variable memory 356 includes a plurality of storage locations including a capacity data file store 400 for storing an XML file, stores 402-408 for storing LEG data, a store 410 for storing coordinates of orientation lines, a store 412 for storing design criteria, a store 414 for storing geometric layout data, and a store 416 for storing a design vehicle database for storing design vehicle parameters. The variable memory 356 may be implemented as a random access memory (RAM) and/or a hard disk drive (HDD) or other non-volatile storage such as flash memory, or a combination thereof.

Capacity Data File

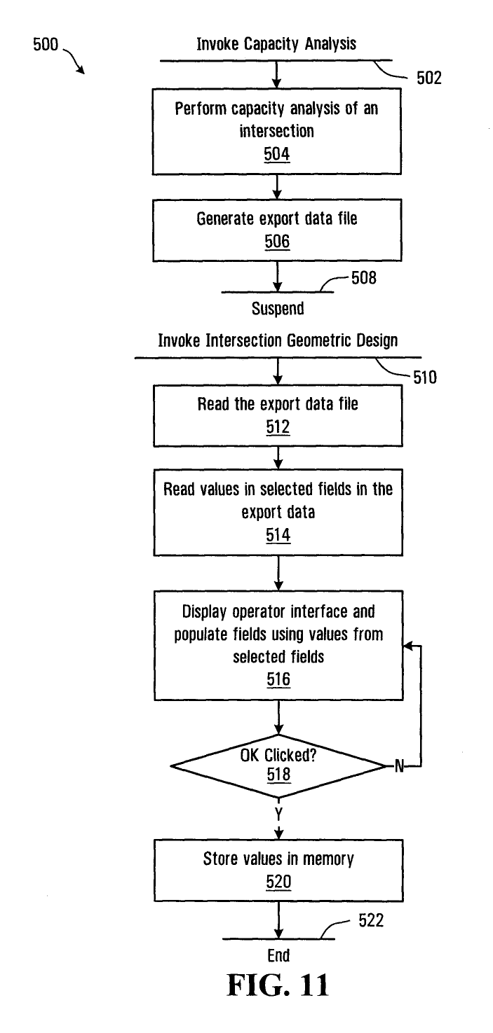

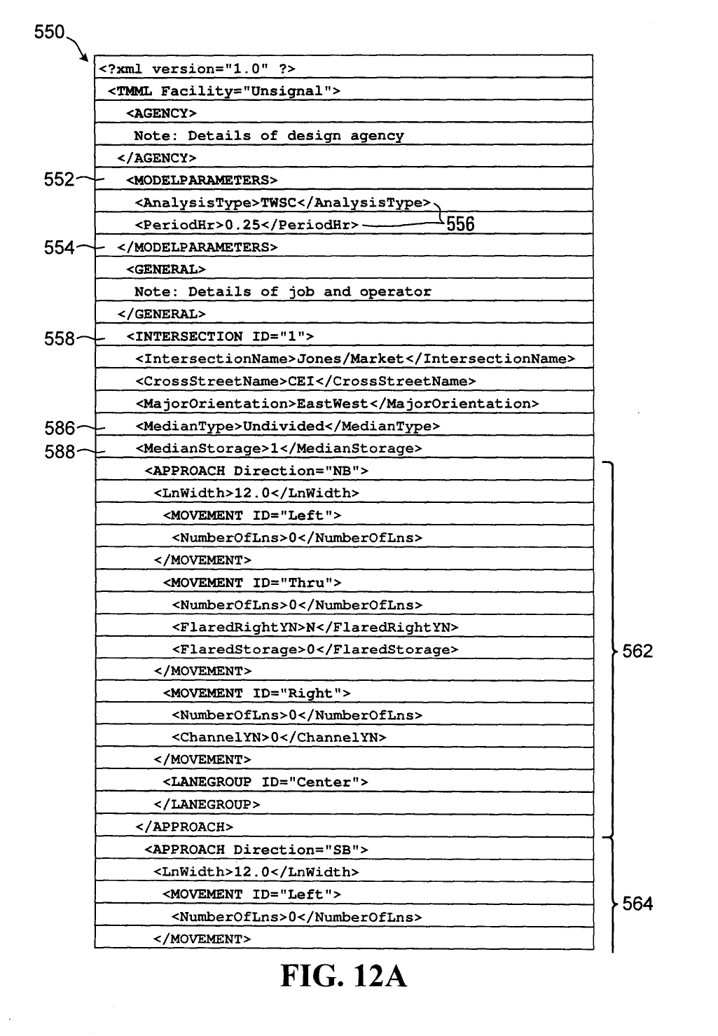

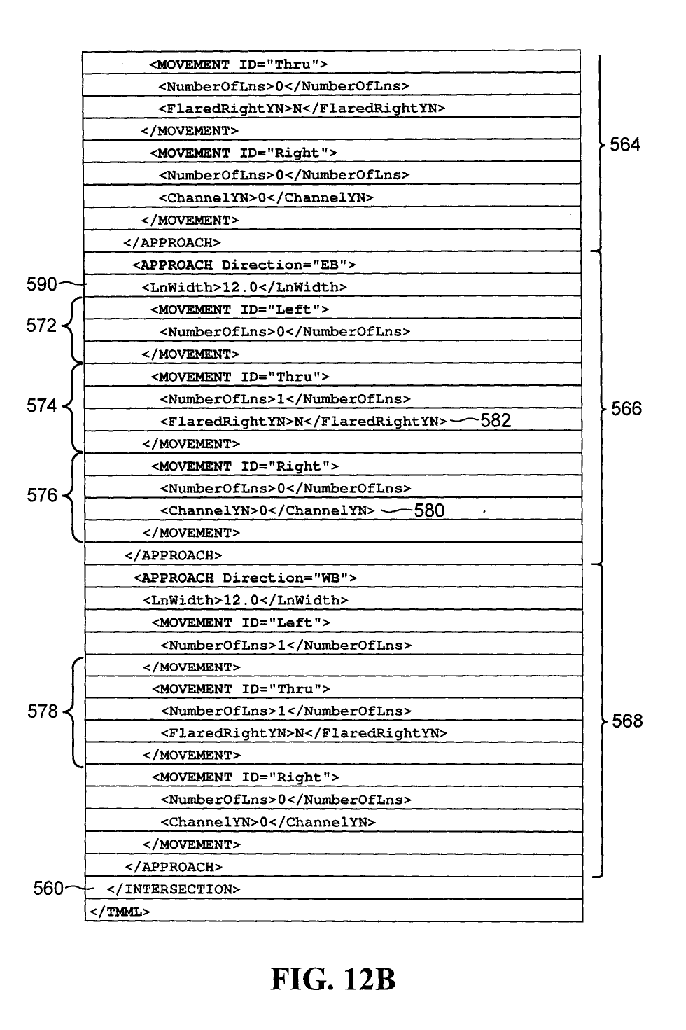

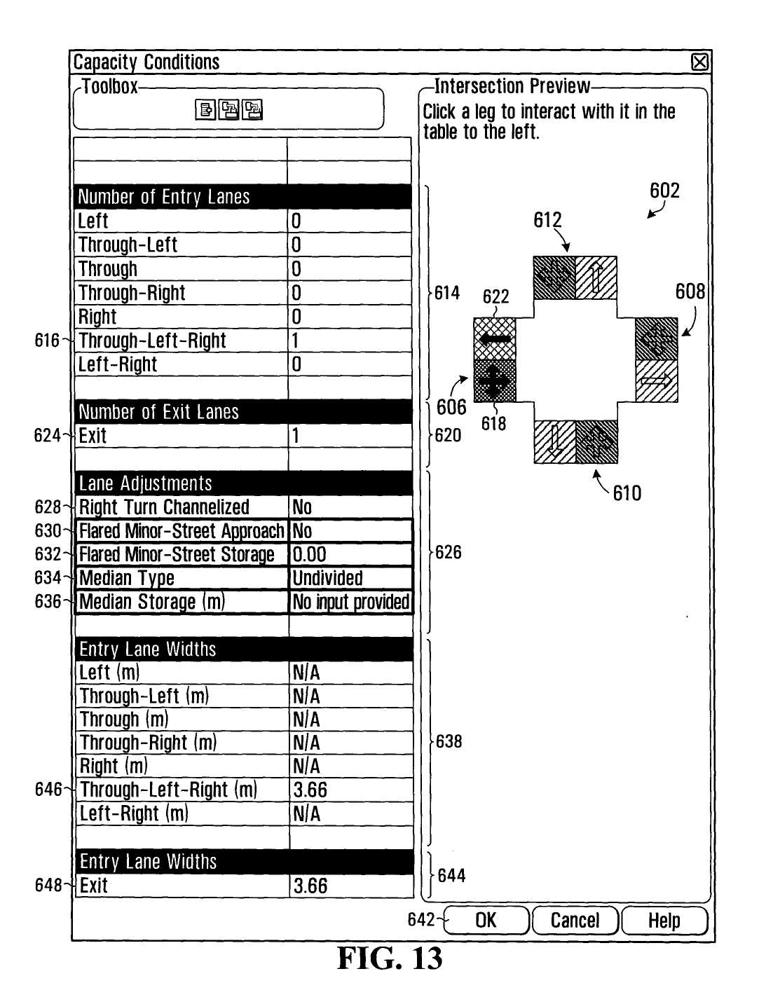

Block 132 of the process 130 shown in FIG. 2 will now be described in greater detail with reference to FIG. 10, FIG. 11, FIG. 12, and FIG. 13.

Referring to FIG. 11, a flowchart depicting blocks of code for directing the processor circuit 350 to carry out process block 132 (shown in FIG. 2) is shown generally at 500. The blocks generally represent codes that may be read from the computer readable medium 380, and stored in the program memory 354, for directing the microprocessor 352 to perform various functions related to receiving the intersection capacity data. The actual code to implement each block may be written in any suitable program language, such as ObjectARX, C, C++ and/or assembly code, for example.

The process begins at 502, which directs the microprocessor 352 to invoke the capacity analysis program codes 370. In this embodiment the capacity analysis system is run on the same processor circuit 350 as the intersection geometric design system, but in other embodiments the capacity analysis system may be run on another processor circuit which is in communication with the processor circuit 350 using a network connection or other data transfer medium such as a memory card, CD ROM, or magnetic disk, for example.

The process 500 then continues at block 504, which directs the capacity analysis system to perform capacity analysis. The capacity analysis may be performed using HCS+, or any other capacity analysis product. In general such products receive input of traffic data and various other operator inputs, and in response generate capacity analysis data for an intersection. The traffic data may include data from a traffic count in the vicinity of an existing or planned intersection.

Block 506 then directs the microprocessor 352 to generate an export data file including the intersection capacity analysis data. Such capacity analysis data generally includes at least the types of data fields listed in Table 1 (FIG. 3), but may also include further data such as signalization timing data, for example. As such, the export data file may include some data fields that are not directly of use in generating the geometric layout of the intersection. The capacity analysis data file may be generated in any of a variety of different formats. In the case of the HCS+ capacity analysis system, an extensible markup language (XML) file is generated. In this embodiment, the XML file is stored in block 400 of the variable memory 356. The process 500 then suspends at 508.

A portion of an exemplary XML capacity data file produced by HCS+ is shown in FIG. 12A and FIG. 12B at 550. Some portions of the XML file that are not particularly relevant to the discussion have been omitted for sake of clarity in FIG. 12. Referring to FIG. 12A, data is arranged between tags such as tags 552 and 554, which provide for convenient identification of data values encoded in the file. The tag 552 is a start tag and the tag 554 is an end tag, which together delineate a portion of the content (in this case related to “model parameters”). The section includes two elements 556, each having a start tag (e.g. <Analysistype>) and an end tag (e.g. </Analysistype>), which demarcate content between the two tags (in this case the content is “TWSC”).

The XML file 550 includes data related to a single intersection between a start tag 558 and an end tag 560 (shown in FIG. 12B). Between these tags 558 and 560 are four sections indicated by braces in FIG. 12, including a northbound approach 562 (NB), a southbound approach 564 (SB), an eastbound approach 566 (EB), and a westbound approach 568 (WB). Under each “Approach” section is a plurality of data values associated with each of the respective legs of the intersection. It should be understood that the format of export data produced by different capacity analysis products will vary significantly from product to product, and files produced by other products may look substantially different to the data file 550 shown in FIG. 12. However, similar data fields to those shown in FIG. 12 may be found or derived from data in export data files generated using other capacity analysis products.

Referring back to FIG. 11, the process 500 resumes at 510 with invoking of the intersection geometric design program codes 368 in the program memory 354 (shown in FIG. 10). Block 512 includes codes for directing the microprocessor 352 to read the XML data file stored in block 400 of the variable memory 356. The process then continues at block 514, which directs the microprocessor 352 to read selected fields in the export data file and to store the content values contained in these fields in the variable memory 356. Clearly, the codes in block 514 will be specific to an export data file produced using a particular capacity analysis product, since the codes direct the microprocessor 352 to locate and extract only certain values from the data file. In the example of the HCS+ XML data file 550 shown in FIGS. 12A and 12B, the codes in block 514 direct the microprocessor 352 to search the XML file for specific start and end tags and read the content between these tags. For example, the codes 514 direct the microprocessor 352 to search for tags having the form of the tag 590 in FIG. 12B which identifies the intersection as having a northbound lane, and would then continue to search within the section 562 for specific values associated with the northbound lane. These specific values will be described in more detail below.

Block 516 then directs the microprocessor 352 to display an operator interface for displaying intersection capacity data to the operator and receiving operator input. An exemplary operator interface is shown in FIG. 13 generally at 600. The operator interface 600 includes a data table 604 and an intersection preview 602, which displays a schematic view of the intersection similar to that shown in FIG. 5. The preview 602 includes an eastbound leg 606, and in this embodiment further includes a westbound leg 608, a northbound leg 610, and a southbound leg 612, as identified in the XML file 550 as included approaches in the respective sections 562, 564,566, and 568. Block 516 also directs the microprocessor 352 to populate the data table 604 using values read at block 514. The data table 604 includes a plurality of fields that are populated from values obtained from the XML file 550. In the preview 602, an eastbound leg 606 is highlighted (appearing in FIG. 13 as a darkened area), which indicates that the specific data displayed in table 604 is associated with the eastbound leg. The data table 604 includes a section 614 defining entry lanes on the eastbound leg 606. The section 614 is populated using values in section 566 of the XML file 550 for “Left”, Thru“, and “Right” movements 572, 574, and 576 respectively (FIG. 12B). The “Left” and Right movements 572 and 576 have content values for the field “NumberOfLanes” of “0”, which indicates that there are no dedicated lanes for these movements, while the “Thru” movement 574 has a content value for the field “NumberOfLanes” of “1” indicating that there is a single lane for this movement. The sections 572-574 are thus interpreted to define a single “Thru” lane, while movements “Left” and “Right are also permitted on the “Thru” lane. Accordingly, the data table 604 includes a “Through-Left-Right” field 616 in section 614 of the data table that has a value set to “1”, indicating that through, left, and right movements are permitted on a single eastbound entry lane 618 as shown in the intersection preview 602.

The data table 604 also includes a section 620 defining exit lanes for the eastbound leg 606. The XML file 550 does not include a field defining the exit lane, and thus the codes in block 514 direct the microprocessor 352 to include a single exit lane 622 on the eastbound leg 606 that corresponds to the single entry lane 618. This is based on an assumption that since the movement 578 in section 568 defines a “Thru” lane on the westbound leg 608, that there will also be a corresponding exit lane 622 on the eastbound leg 606. Accordingly an exit field 624 in the table 604 is set to “1”.

The data table 604 also includes a section 626 defining lane adjustments. The lane adjustments 626 include a number of fields populated from the XML file 550. For example a “right turn channelized” field 628 is populated from a field 580 in FIG. 12B, a “flared minor-street approach” field 630 is populated from a field 582, a “flared minor-street storage” field 632 does not have a corresponding value in section 566 of FIG. 12B, and is thus set to a value of “0.00”. A “median type” field 634 is populated from a field 586 in FIG. 12A, and a “median storage” field 636 is populated from a field 588 in FIG. 12A. These fields generally apply to adjustments to the lane geometry that may be included to accommodate the traffic flows through the intersection.

The data table 604 also includes a section 638 defining entry lane widths. In this case the width of the “Through-left-right” lane 618 is taken from a lane width field 590 in FIG. 12B and this value is written to a field 646 in the table 604. Since the XML file 550 includes dimensions in feet (i.e. 12.0 ft), the value in the field 617 is converted into metric units as 3.66 meters for display in the table 604, which is configured for metric units.

The data table 604 also includes a section 644 defining exit lane widths. As noted above, the XML file 550 does not include a field defining the exit lane, and thus the codes 514 direct the microprocessor 352 to set an exit lane width field 648 to the same value as the entry lane width in the field 646.

In the embodiment shown, the operator interface 600 further provides an opportunity for the operator to edit values in the table 604 and to add additional values where desired. Such edits will be reflected in the preview 602.

The sections 562, 564, and 568 of the XML file 550 may be similarly processed to populate and store values for the northbound leg 610, the westbound leg 608, and the southbound leg 612 in respective memory blocks 404-408 of the variable memory 356.

The operator interface 600 also includes an “OK” button 642. Block 518 directs the microprocessor 352 to determine whether the OK button 642 has been actuated, in which case block 518 directs the microprocessor 352 to block 520. Block 520 directs the microprocessor 352 to store the values in the data table 604 in the respective blocks 402-408 of the variable memory 356. The process 500 then ends at 522. If at block 518 the “OK” button 642 is not actuated, then block 518 directs the microprocessor 352 to continue receiving operator input at block 516.

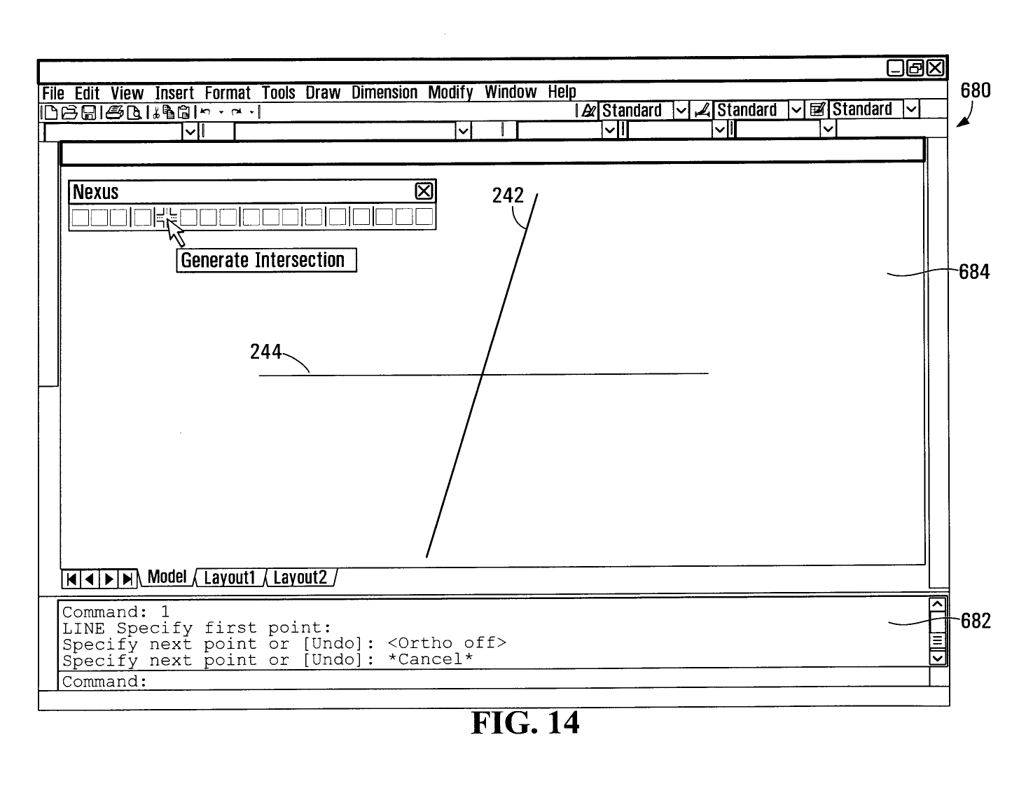

In one embodiment the intersection geometric design system is implemented on the AutoCAD platform as described earlier herein. Referring to FIG. 14, a screenshot of a user interface, which is displayed by the AutoCAD system, is shown generally at 680. The user interface 680 provides a command line interface 682 for receiving text input from the operator (via the keyboard 110 shown in FIG. 10). The interface 680 also provides a graphical interface 684 for receiving graphic input from the operator (via the pointing device 112 shown in FIG. 10).

Referring back to FIG. 2, block 134 of the process 130 may be implemented using CAD functions provided by AutoCAD. The CAD system program codes 368 (shown in FIG. 10) provide access to CAD functions for receiving input of reference lines 242 and 244, which as described earlier in connection with FIG. 6 define the physical orientation of the intersection. The intersection geometric design codes 368 in FIG. 10 include codes that direct the microprocessor 352 to receive input of coordinates of the reference lines 242 and 244 and to store the coordinates of the lines in block 410 of the variable memory 356. The operator may use either the command line interface 682 or the graphical interface 684 to input the orientation data.

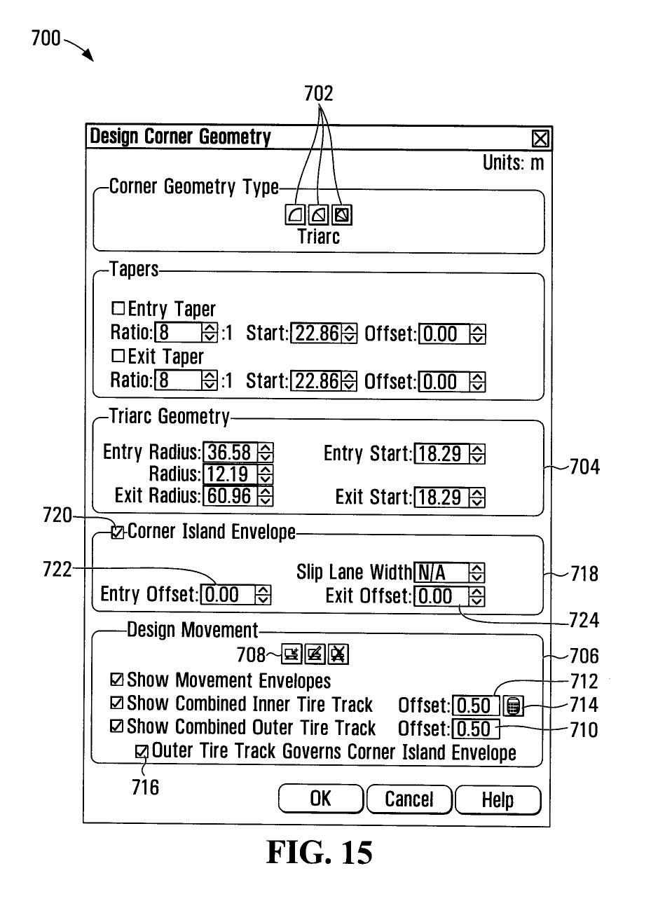

Referring to FIG. 15, a screenshot of an exemplary operator interface for receiving operator input of design values associated with the generation and/or editing of corner geometry is shown generally at 700. The design interface 700 includes a group of three buttons 702 for selecting the corner geometry type between a simple arc, 2-centered compound curve (biarc), or 3-centered compound curve (triarc), of which the triarc is selected in the embodiment shown. The design interface 700 also includes a “Triarc Geometry” group of controls 704, including fields for receiving operator input of a radius, entry radius, and exit radius associated with the 3-centered arc. In one embodiment, default design values for the radius, entry radius, and exit radius are read from the design criteria store 412 (shown in FIG. 10) and are used to populate the radius, entry radius, and exit radius controls. The operator may accept the default values, or make changes to these values as desired. When the operator changes any of the values of radius, entry radius, or exit radius, the intersection geometric design codes 368 (shown in FIG. 10) directs the microprocessor 352 to store the values in the geometric layout data store 414.

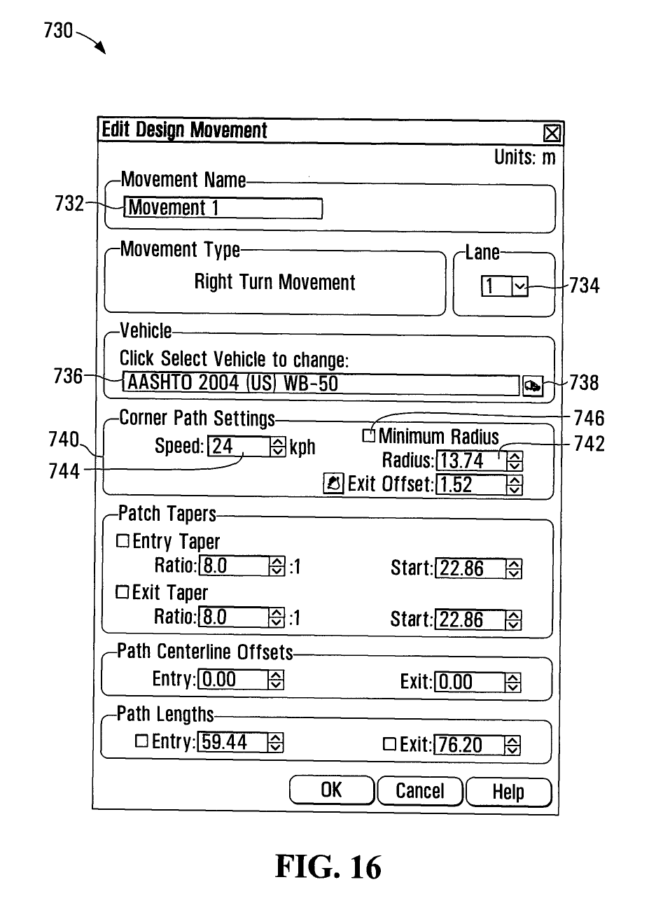

As disclosed above in connection with FIG. 9, the corner geometry for the transition between the approach 286 and exit 304 may be defined by a geometric shape such as a simple arc or a triarc, in which the applicable radii are set to a default value and may be adjusted by the operator using the group of controls 704. Using such geometric shapes may not generate optimal corner geometry, in that a prescribed or selected design vehicle for the permitted movement may have a swept path that is not accommodated within the extents of the intersection. Alternatively, the swept path of the design vehicle may leave unused pavement space within the extents of the intersection. Referring back to FIG. 15, in this embodiment the design interface 700 also includes a “Design Movement” group of controls 706 including an “edit design movement” button 708. Actuating the button 708 directs the microprocessor 352 to display a design movement interface. Referring to FIG. 16, an exemplary design movement interface is shown generally at 730. The interface 730 is associated with one specific turning movement, in this case a right turn movement as indicated at 732. For example, with reference to FIG. 9, the right turn movement may correspond to a right turn between the westbound roadway portion 310 and the northbound roadway portion 288. This right turn movement would be associated with the generation of the transition 332 between these roadway portions. The interface 730 also includes a lane selection control 734 that provides for selection of the lane to which the movement is to be applied (in this case lane 1 since there is only a single lane).

The interface 730 further includes a design vehicle selection control 736 that facilitates operator selection of a design vehicle for the movement. In some cases, the selection of a particular design vehicle for a particular movement such as a right turn is prescribed by design guidelines. In this case the selected design vehicle is a 50 ft semitrailer vehicle (WB-50). Other design vehicles may be selected from a list (not shown) displayed by clicking on a design vehicle button 738.

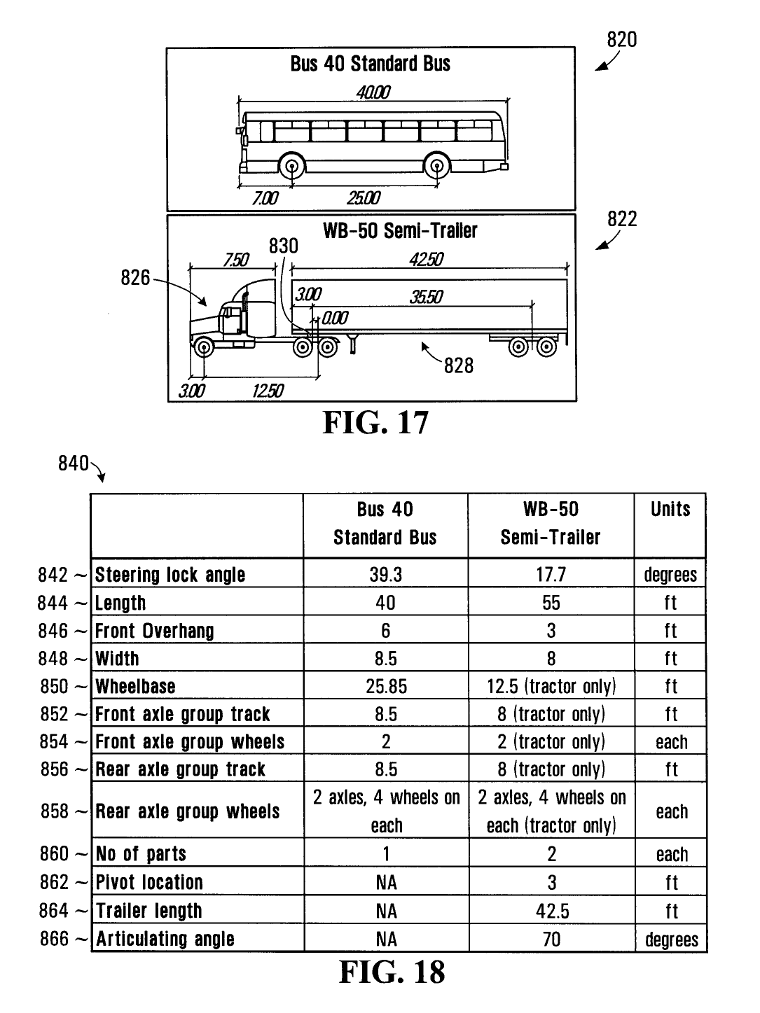

Referring to FIG. 17, a side view representations of exemplary design vehicles are shown at 820 and 822. The design vehicle 820 is a standard bus (BUS-40) and the design vehicle 822 is a semi-trailer (WB-50), both defined in the American Association of State Highway and Transportation Officials (AASHTO) library of standard design vehicles.

The design vehicles 820 and 822 are defined by a plurality of design vehicle parameters stored in the design vehicle database 416 (shown in FIG. 10). Referring to FIG. 18, a table listing exemplary parameters for the design vehicle 820 is shown generally at 840. The parameter listing 840 includes a steering lock angle parameter 842 representing an angle through which the steering of the vehicle is capable of turning from a straight ahead condition. The parameter listing 840 also includes dimensions for overall vehicle length 844, front overhang 846, body width 848, and wheelbase 850. The front overhang dimension 846 is taken from the center of the front wheel to the front extent of the vehicle and the wheelbase is the dimension between front and rear axles of the vehicle. The wheelbase dimension 850 is taken between the center of the front wheel and the center of a rear axle group, which includes two spaced apart axles each having 4 wheels.

The parameter listing 840 also includes parameters associated with a front axle group, including the number of wheels per axle 854 and a track dimension 852. In this embodiment, the track dimension 852 is the distance between outer edges of the tire tread measured across the axle. Conventionally, track dimensions generally refer to a distance between respective centers of the outer wheel tire tread, but for intersection design the outside of the tire tread is relevant for defining intersection features. Accordingly, when populating the design vehicle database 416, conventional track dimensions are adjusted to correspond to the distance between the outer edges of the tire tread measured across the axle.

The parameter listing 840 also includes parameters associated with a rear axle group, including the number of wheels per axle 858 and a track dimension 856. The parameter listing 840 further includes a number of parts parameter 860, which when set to “1” indicates that the vehicle is an unarticulated vehicle, and for values of “2” or higher indicates that the vehicle articulated. The vehicle 822 is articulated and includes a tractor portion 826 and a trailer portion 828 connected to the tractor portion at a pivot location 830. The parameter listing also includes a pivot location dimension 862, which is referenced to the center of the rear axle group of the tractor 826.

The parameter listing 840 also includes trailer parameters, such as a trailer length parameter 864 and an articulating angle parameter 866. The articulating angle parameter 866 represents is a maximum angle that may exist between a longitudinal centerline of a tractor portion 826 and a longitudinal centerline of a trailer portion 828 when turning the vehicle.

In general, the design vehicle database 416 would stores sets of parameters 840 for a plurality of design vehicles, such as the vehicles 820 and 822. Libraries of various standard design vehicles are implemented in the AutoTURN® software product available from Transoft Solutions Inc. of British Columbia, Canada. The libraries include commonly used design vehicles for different countries and also provide for custom definition of vehicles not available in the standard libraries. Other design vehicles such as a passenger vehicle (P) are commonly used for other aspects of intersection design. For example, a passenger vehicle may be used for the evaluation of site-lines through the intersection.

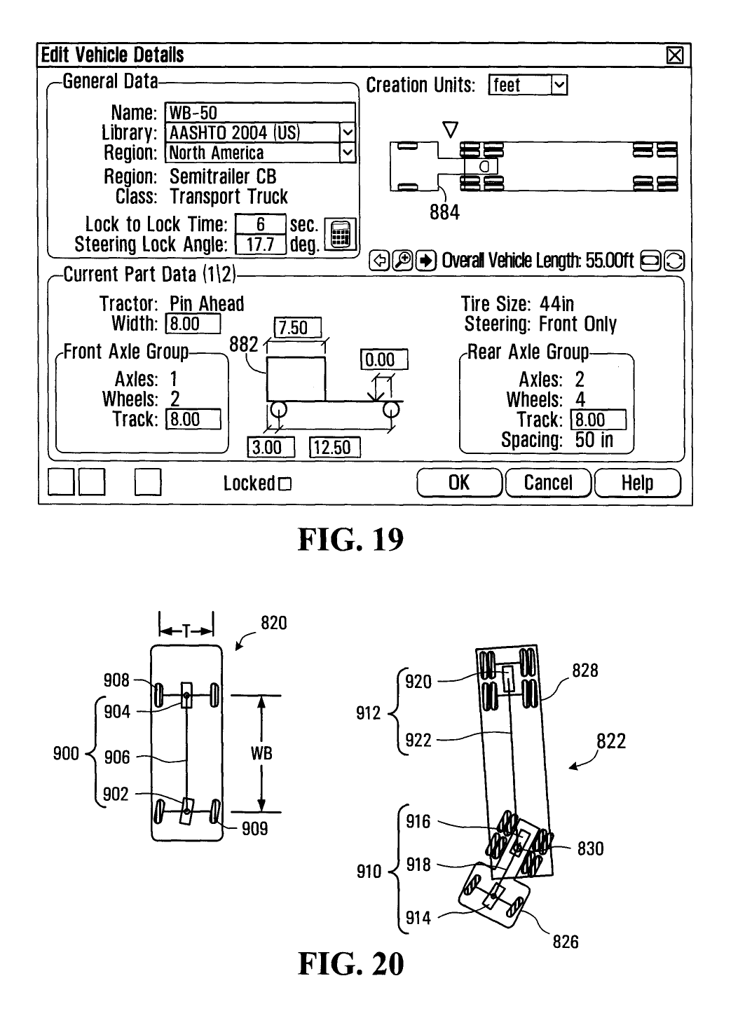

Referring to FIG. 19, an operator interface displayed by AutoTURN for entering or editing design vehicle parameters stored in the database 416 is shown generally at 880. In this embodiment, the vehicle 822 is represented by generally simple box shapes 882 and 884 and the operator inputs various dimensions for the design vehicle in the fields provided. In other embodiments, more realistic design vehicles may be provided by modifying the box shapes 882 and 884 to more accurately represent the actual vehicle shape.

In this embodiment, when generating corner geometry using the swept path of the design vehicle, a bicycle model is used to represent the design vehicle. The use of a bicycle model simplifies computation of coordinate locations along the turning path, thereby providing improved computational efficiency.

Referring to FIG. 20, a bicycle model 900 for the BUS-40 design vehicle 820 includes a front wheel 902 and a rear wheel 904, which are separated by a distance 906 corresponding to a wheelbase dimension of the design vehicle 820. The front and rear wheels 902 and 904 are centered between the respective front and rear wheels of the design vehicle 820 (i.e. the front and rear wheels are each located at half of the respective track dimensions 852 and 856 shown in FIG. 18). In the embodiment shown, the front wheels of the design vehicle 820 are steerable and the corresponding front wheel 902 of the bicycle model 900 is also steerable while the rear wheel 904 of the bicycle model is fixed. In other embodiments the design vehicle 820 may have steerable rear wheels, in place of or in addition to steerable front wheels, and the bicycle model 900 may thus include a corresponding steerable rear wheel 904 or steerable front and rear wheels.

For any arbitrary location of the bicycle model 900, the design vehicle parameters stored in the design vehicle database 416 may be used to determine corresponding locations of the wheels of the design vehicle. For example, the front left hand wheel 909 of the design vehicle 820 is spaced apart from the front wheel 902 of the bicycle model by half of the track width dimension 852 in a direction perpendicular to the wheelbase 906. Locations of other vehicle extents, such as the right hand rear wheel 908, may be similarly computed using the design vehicle parameters.

For more complex design vehicles such as the design vehicle 822 shown in FIG. 20, a representative bicycle model 910 may be generated that includes a bicycle model portion 910 for the tractor portion 826 of the design vehicle and a bicycle model portion 912 for the trailer portion 828 of the design vehicle. The bicycle model portion 910 includes front and rear wheels 914 and 916 separated by a distance 918 corresponding to a wheelbase dimension of the tractor 826. The bicycle model portion 912 includes a fixed rear wheel 920, which is separated by a distance 922 from the pivot 830. The distance 922 corresponds to a wheelbase dimension of the trailer portion 828 of the design vehicle 822. In other embodiments the rear wheel 920 may also be steerable to correspond to an articulated vehicle having rear wheels of the trailer portion 828 coupled to a steering mechanism to facilitate improved steerability of the articulated vehicle.

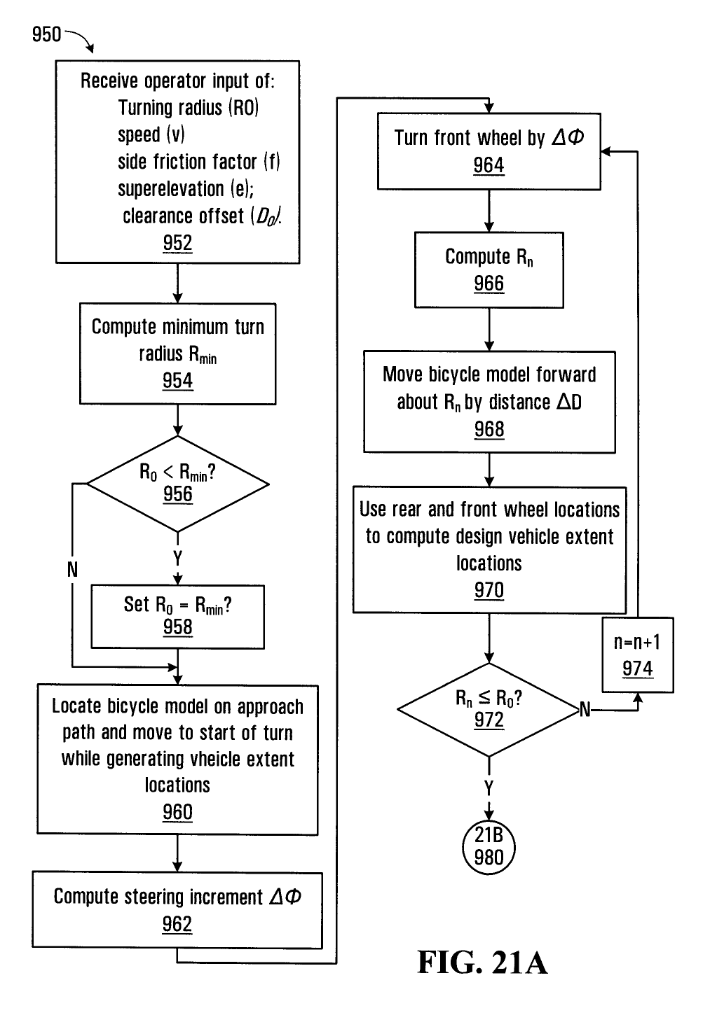

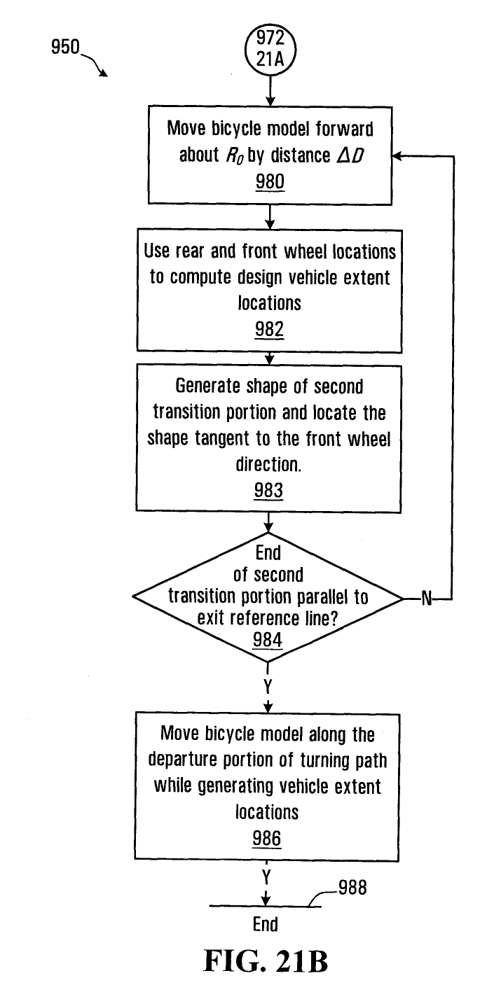

A flowchart depicting blocks of code for directing the processor circuit 350 to implement a process for generating the corner geometry from the design vehicle swept path is shown at 950 in FIG. 21A and FIG. 21B.

Referring to FIG. 21A, the process begins at block 952, which directs the microprocessor 352 to receive operator input of a plurality of parameters for generating the turning path using the operator interface 730 shown in FIG. 16. The operator interface 730 includes a control group 740 for receiving operator input of a radius 742 (R₀) for a turning path of the vehicle and a speed 744 (v) of the design vehicle through the turn. The control group 740 also includes a checkbox control 746, which when actuated by the operator directs the microprocessor 352 to populate the radius 742 with a value corresponding to the minimum turn radius of the design vehicle selected in the design vehicle selection control 736. In other embodiments the interface 730 may include fields for entering a side friction factor f associated with a surface of the first and second roadway portions and a superelevation parameter e defining a cross-slope of the roadway. In the embodiment shown these values are stored as default values in the store 412 of the variable memory 356, and are read from the store.

Referring back to FIG. 15, the design interface 700 also provides for entry of an inner track clearance allowance offset value 710 (D) and an outer track clearance allowance offset value 712 Dₒ. The parameters R, v, f, e, and D₀ are stored in the store 414 of the variable memory 356.

Block 954 then directs the microprocessor 352 to compute a minimum turn radius Rₘᵢₙ. In this embodiment the minimum turn radius is computed in accordance with the formula:

$${R}_{min} = \frac{{v}^{2}}{127 ( \frac{e}{100} + f )} \qquad Eqn 1$$

where:
Rₘᵢₙ is the minimum turn radius in meters;
v is the speed of the design vehicle in kilometers per hour;
e is the superelevation; and
f is a side friction factor.

The radius Rₘᵢₙ is computed using the values stored in the store 412 of the variable memory 356 and the computed Rₘᵢₙ value is stored in the store 414. Note that for units other than meters and kilometers, the values of the numerical constants in Eqn 1 would have to be modified accordingly.

Block 956 then directs the microprocessor 352 to determine whether the turn radius R₀ input by the operator is less then the minimum turn radius Rₘᵢₙ, in which case block 958 directs the microprocessor 352 to write the value of Rₘᵢₙ into the store 414 as the turning radius R₀. In other embodiments block 958 may direct the microprocessor 352 to generate a warning signal for displaying a warning to inform the operator that the selected turn radius is not a feasible turn radius. For example, the warning signal may cause an audible tone to be generated and/or causing an operator interface to be displayed to alert the operator. If at block 956 the turn radius R₀ input by the operator is not less than the minimum turn radius Rₘᵢₙ the process continues at block 960.

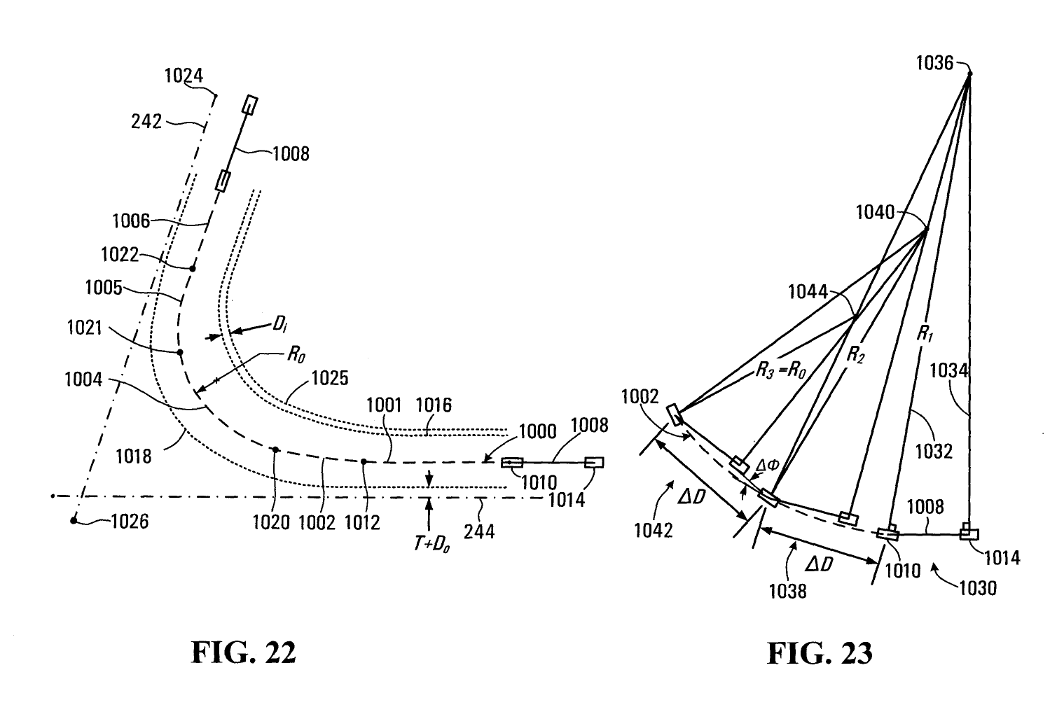

The right turn movement between the westbound roadway portion 310 and the northbound roadway portion 288 in FIG. 9 is shown in greater detail in FIG. 22. Referring to FIG. 22, the turning movement path is shown as a dashed line at 1000, and includes an approach portion 1001, a first transition portion 1002, a circular arc turning portion 1004, a second transition portion 1005, and a departure portion 1006. The approach portion 1001 is aligned with the second reference line 244 and the departure portion 1006 is aligned with the first reference line 242. As noted above, while in the embodiment shown the reference lines 242 and 244 are straight lines, in other embodiments the reference lines may be curved and the approach and departure portions 1001 and 1006 may have corresponding curvatures that correspond to a curvature of the reference lines.

Block 960 then directs the microprocessor 352 to locate a bicycle model 1008 of the selected design vehicle on the approach portion 1001 of the path 1000 and then to move the bicycle model along the approach path by successive increments of ΔD until a front wheel 1010 of the bicycle model is at a start 1012 of the first transition portion 1002. In this embodiment, the approach portion 1001 is spaced inwardly from the second reference line 244 by a distance corresponding to half of the front axle track the design vehicle, and the further offset Dᵢ (712 in FIG. 15) is added to provide a clearance allowance for the vehicle traveling through the intersection. The bicycle model 1008 represents the design vehicle, which in this example is an unarticulated vehicle such as the Bus-40 vehicle 820 shown in FIG. 20.

Block 960 also directs the microprocessor 352 to compute vehicle extent locations at each location along the approach portion 1001. Referring back to FIG. 20, for the turn shown in FIG. 22, the vehicle extents are defined by the right hand rear wheel 908 and the left hand front wheel 909 of the design vehicle 820. The selection of these wheels as defining the vehicle extents is based on the assumption that while the wheel 908 should clear any curb, other vehicle features that may protrude beyond the wheels are located at a sufficient height to pass above the curb. Should the curb be higher than usual, or any other vehicle features be located at a height which would cause it to encroach on the curb, such features may be selected as defining the vehicle extents in preference to the right hand rear wheel 908 and the left hand front wheel 909. Referring back to FIG. 21A, block 960 also directs the microprocessor 352 to write coordinate values of locations of the front and rear wheels 1010 and 1014 along the approach portion 1001 and coordinates of the corresponding vehicle extents of the design vehicle to the store 414 of the variable memory 356.

Referring back to FIG. 22, the vehicle extent locations for the left hand front wheel 909 are shown at 1016 and the vehicle extent locations for the right hand rear wheel 908 are shown at 1018. The vehicle extent locations 1016 and 1018 each include a successive plurality of coordinate locations spaced apart by a distance ΔD.

The first transition portion 1002 of the turning path 1001 represents a portion of the turn during which a driver of the design vehicle would be turning the steering to cause the vehicle to begin steering through the turn. In this embodiment, the first transition portion 1002 has a generally spiral shape having reducing radius as the bicycle model 1008 moves along the first transition portion.

Block 962 then directs the microprocessor 352 to compute a steering increment Δφ. In this embodiment the steering increment is computed in accordance with the following formulae:

$$S R = \frac{2 {φ}_{LA}}{{t}_{L}} \qquad Eqn 2$$

where:
SR is the steering rate in degrees/second;
φ_{LA} is the steering lock angle (from FIG. 18); and
t_{L} is the time for an average driver to steer from a left hand steering lock condition to a right hand steering lock condition or vice versa.

The value of t_{L} may be measured for each design vehicle under driving conditions, or a default value (such as 6 seconds) may be assumed for the design vehicle. The steering increment is then computed from:

$$Δφ = S R \frac{Δ D}{v} \qquad Eqn 3$$

where:
ΔD is the distance increment;
v is the speed of the design vehicle through the turn; and
Δφ is the steering increment per distance increment.

In one embodiment the distance increment ΔD is set to 4 inches. The value of the steering increment Δφ is then written to the store 414 of the variable memory 356.

Block 964 then directs the microprocessor 352 to read the value of Δφ from the store 414 and to turn the front wheel of the bicycle model by an angle corresponding to Δφ.

The first transition portion 1002 of the turning path 1001 is shown in greater detail in FIG. 23. Referring to FIG. 23, the bicycle model 1008 is shown in a first location 1030, with the front wheel 1010 having been turned through the angle Δφ while a rear wheel 1014 remains stationary.

Block 966 then directs the microprocessor 352 to compute a value of an instantaneous turn radius Rₙ (where n=1, 2, 3 . . . ). Computing the first radius R₁ involves determining an intersection between lines 1032 and 1034, which each extend perpendicularly outward from the respective front and rear wheels 1010 and 1014, in accordance with the formula:

$${R}_{n} = \frac{WB}{sin n Δφ} \qquad Eqn 4$$

where n=1 for calculating the radius R₁ at the first location 1030, and WB is the wheelbase of the design vehicle, which for the design vehicle 820 is the value 850 of 25.85 ft from the parameter listing 840 in FIG. 18 (and which is read from the design vehicle database 416, shown in FIG. 10).

The Radius R₁ defines a center of rotation 1036 for a first movement of the bicycle model 1008 along the first transition portion 1002 from the first location 1030. Block 968 then directs the microprocessor 352 to read the value of ΔD from the store 414 of the variable memory 356 and to move the bicycle model through an arc about the center of rotation 1036 to a second location 1038, such that the front wheel 1010 is displaced by a distance ΔD from the first location.

Block 970 then directs the microprocessor 352 to use the locations of the front and rear wheels 1010 and 1014 of the bicycle model to compute corresponding vehicle extent locations for the design vehicle using the values of design vehicle parameters for the design vehicle read from the design vehicle database 416. The vehicle extent locations are shown at 1016 and 1018 in FIG. 22. Block 970 also directs the microprocessor 352 to write coordinate values of locations of the front and rear wheels 1010 and 1014 along the first transition portion 1002 and coordinates of the corresponding vehicle extents of the design vehicle to the store 414 of the variable memory 356.

The process then continues at block 972, which directs the microprocessor 352 to read the value of R₀ (the operator defined turn radius) and to determine whether Rₙ is less than or equal to R₀. If Rₙ is still greater than R₀, block 972 directs the microprocessor 352 to block 974, where n is incremented. Block 974 then directs the microprocessor 352 back to block 964 and the blocks 964 to 972 of the process 950 are repeated. At the repeat of block 964, the front wheel 1010 is turned through a further angle Δφ, and the radius R₂ is computed using Eqn 4 with n=2. The radius R₂ defines a new center of rotation 1040 for moving the bicycle model 1008 from the second location 1038 to a third location 1042.

It should be noted that in FIG. 23, the spacing ΔD is exaggerated for sake of clarity. In practice, as mentioned above, ΔD may be a small increment of about 4 inches thus producing a large plurality of locations along the turning path 1001 and the a corresponding large plurality of vehicle extent locations 1016 and 1018.

If at block 972, the radius Rₙ matches the radius R₀ specified by the operator (as is the case for R₃), the first transition portion 1002 of the turning path 1001 is completed and the circular arc turning portion commences at a point 1020.

Once the circular arc portion 1004 is reached, the steering angle of the front wheel 1010 is held constant. Referring to FIG. 21B, block 980 then directs the microprocessor 352 to move the bicycle model 1008 forward about the rotational center 1044 by successive increments of ΔD. Bock 982 then directs the microprocessor 352 to use the locations of the front and rear wheels 1010 and 1014 of the bicycle model to compute corresponding vehicle extent locations for the design vehicle. Block 982 also directs the microprocessor 352 to write coordinate values of locations of the front and rear wheels 1010 and 1014 and coordinates of the corresponding vehicle extents of the design vehicle to the store 414 of the variable memory 356.

Block 983 then directs the microprocessor 352 to generate a mirrored shape of the first transition portion 1002 for generating a second transition portion 1005. Mirror functions for shapes are generally provided in many CAD systems, and may be applied to produce a target shape that is a mirror image of an input shape. The mirrored shape is then positioned so that a first end of the mirrored curve (corresponding to the point 1020 on the first transition portion) is located tangent to the front wheel 1010.

The process then continues at block 984, which directs the microprocessor 352 to determine whether a second end of the shape of the second transition portion 1005 is parallel to the reference line 242. If the second end is not parallel to the reference line 242 then block 984 directs the microprocessor 352 back to block 980, and blocks 980 to 984 are repeated.

If at block 984, the second end of the second transition portion is parallel to the reference line 242 then the circular arc portion 1004 of the turning path 1001 is completed at a point 1021, and the mirrored shape is correctly positioned and forms the second transition curve 1005. The second transition curve 1005 extends between the points 1021 and 1022, and represents a portion of the turn during which a driver of the design vehicle is turning the steering to cause the vehicle to begin steering out of the turn. In this embodiment, the second transition portion 1005 has a generally spiral shape having increasing radius as the bicycle model 1008 moves along the second transition portion.

Block 986 then directs the microprocessor 352 to move the bicycle model along the second transition portion 1005 and the departure portion 1006 by successive increments of ΔD and to compute vehicle extent locations at each location along the turning path 1000. At each successive increment the steering angle φ is decremented by Δφ, where Δφ is an angle between the current steering angle of the front wheel of the bicycle model 1010 and a line drawn tangent to the turning path 1000 at each successive location. The front wheel of the bicycle model 1008 is then moved to the next successive location located ΔD along the turning path 1000. At each successive location, bock 986 also directs the microprocessor 352 to use the locations of the front and rear wheels 1010 and 1014 of the bicycle model to compute corresponding vehicle extent locations for the design vehicle. Block 986 further directs the microprocessor 352 to write coordinate values of locations of the front and rear wheels 1010 and 1014 along the second transition portion 1005 and the departure portion 1006 and coordinate values of the corresponding vehicle extents of the design vehicle to the store 414 of the variable memory 356. The process 950 then ends at 988.

In other embodiments, the first and/or second transition portions (1002, 1005) of the turning path 1001 may be omitted, thus representing the turning path using only the approach portion 1001, the circular arc turning portion 1004 specified by the operator input radius R₀, and the departure portion 1006.

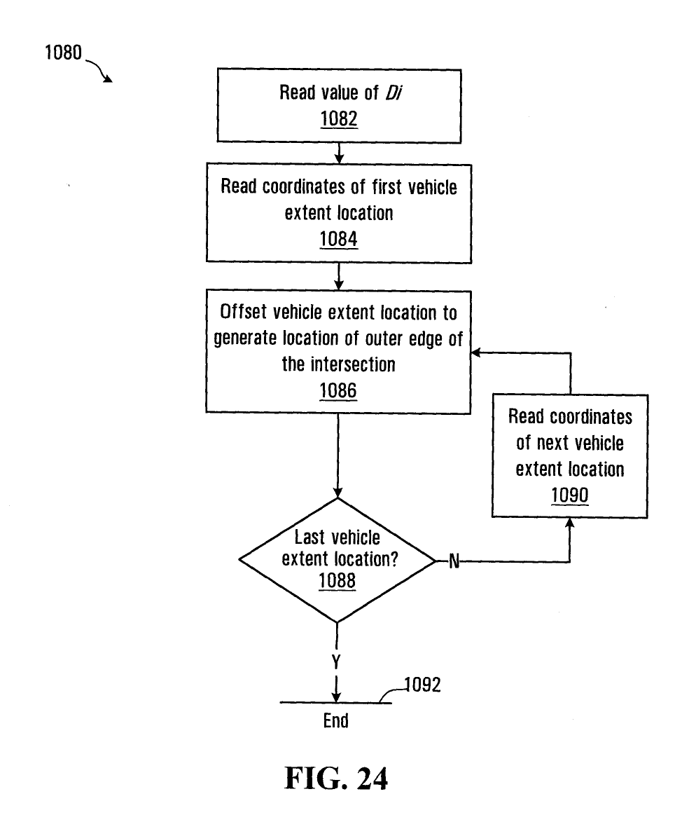

A flowchart depicting blocks of code for directing the processor circuit 350 to implement a process for generating the corner geometry of the intersection in accordance with one embodiment of the invention is shown at 1080 in FIG. 24. The process begins at block 1082, which directs the microprocessor 352 to read the value of the offset Dᵢ from the store 414 of the variable memory 356. Block 1084 then directs the microprocessor 352 to read coordinates of a first vehicle extent location of the vehicle extent locations 1018 from the store 414.

Block 1086 then directs the microprocessor 352 to offset the vehicle extent location to generate an offset vehicle extent location 1025, which may be used to define the corner geometry of the roadway portion. In one embodiment, offsetting the vehicle extent locations involves constructing a line joining locations of a previous vehicle extent location and a next vehicle extent location to define a tangent line to the current vehicle extent location. The offset Dᵢ is then applied to the current vehicle extent location in a direction perpendicular to the tangent line.

Block 1088 then directs the microprocessor 352 to determine whether the current vehicle extent location is the last vehicle extent location, in which case the process ends at 1092. If at block 1088 the current vehicle extent location is not the last vehicle extent location, then the process continues at block 1090, which directs the microprocessor 352 to read coordinates of the next vehicle extent location from the store 414 of the variable memory 356.

In an alternative embodiment, the offset Dᵢ may not be a fixed offset distance but may vary along the vehicle extent locations such that some vehicle extent locations are offset by a greater distance than other vehicle extent locations to generate the outer edges of the intersection. In another alternative embodiment of the process 1080, CAD system functions may provide an offset function for offsetting a curve by a fixed distance, and such a function may be invoked to offset the vehicle extent locations to generate the outer edges of the intersection.

In this embodiment, the process 1080 generates the offset vehicle extent location 1025 including a plurality of locations for defining the corner geometry. Referring back to FIG. 15, in the embodiment shown the design interface 700 also includes a “calculate” button 714. When the calculate button 714 is actuated by the operator, the microprocessor 352 is directed to compute a radius, entry radius, and exit radius that best conforms to the offset vehicle extents 1025 that were established using the design vehicle swept path. Advantageously, defining the corner geometry using a triarc (or a simple arc or biarc) provides simpler geometric features for easier layout of the physical intersection, since the corner geometry when defined by the offset vehicle extents 1025, may require definition through a polyline or other more complex curve construct.

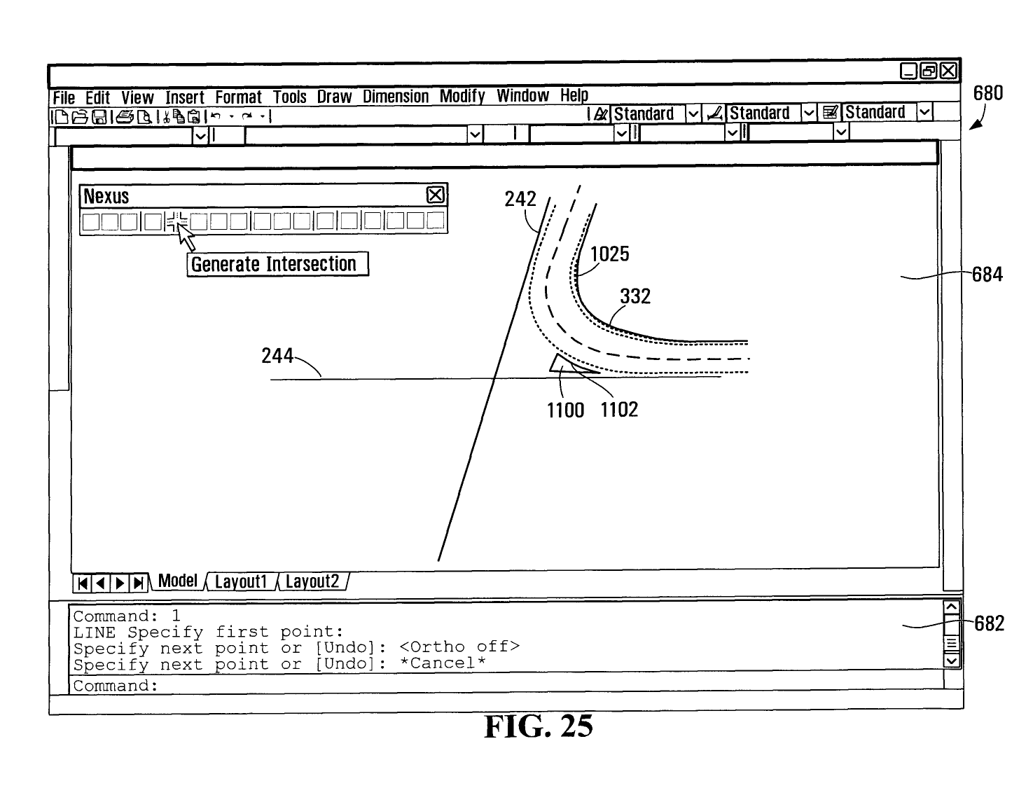

In this embodiment where a “triarc” is selected at 702, three radii are available to conform the triarc geometry to the offset design vehicle extents 1025. In other embodiments where a biarc or simple arc is used, there may be a greater deviation between the offset vehicle extents 1025 and the corner geometry defined by the biarc or simple arc. An updated screenshot of the user interface 680 is shown in FIG. 25, in which the offset vehicle extent location 1025 and the corner geometry 332 as defined by the calculated triarc are shown.

Referring back to FIG. 15, the design interface 700 further includes a corner island envelope group of controls, including a checkbox 720. When the checkbox 720 is checked, the microprocessor 352 is directed to generate a corner island envelope having an entry offset and exit offset as defined by the fields 722 and 724 in the control group 718. The design interface 700 also includes a checkbox control 716, which when actuated directs the microprocessor 352 to use the vehicle extents associated with the outer tire track to determine geometry associated with a corner island envelope.

Referring to FIG. 25, an exemplary corner island envelope is shown at 1100. A corner island envelope is a region in the intersection within which a corner island may be constructed, if desired. As such the physical corner island should not encroach beyond the extents of the corner island envelope 1100. The corner island envelope has an extent 1102 adjacent the design vehicle swept path, and in the embodiment shown this extent conforms to the design vehicle swept path extent, and is spaced apart therefrom.

Referring again to FIG. 22, in one embodiment the reference line 242 includes first and second movable endpoints 1024 and 1026 which allow the operator to use the pointing device 112 (shown in FIG. 10) to select and drag one of endpoints to a new location, thereby changing the relative orientation between the first and second reference lines. Similarly, the reference line 244 may also include moveable endpoints (not shown) allowing changes in orientation of the second roadway and/or a change in a location of the intersection area between the first roadway and the second roadway.

When one of the endpoints 1024 or 1026 is moved to another location, blocks 140 and 142 of the process 130 of FIG. 2 are repeated, thereby generating display signals for causing the computer display 116 (shown in FIG. 10) to update the representation of the intersection in response to the change. Similarly, other changes, such as changes to the operator input parameters stored in the store 414 of the variable memory 356, or a change in selection of the design vehicle, will generally also require that these blocks of the process 130 be repeated. Accordingly, at each change, the microprocessor 352 is directed to regenerate the turning path of the design vehicle, regenerate the vehicle extent locations, and regenerate the outer edges of the intersection area as described above with reference to FIG. 21A and FIG. 21B.

Advantageously, the intersection geometric design system 100 facilitates generation of a physical geometric layout of an intersection from data provided in a capacity analysis of the intersection. Since capacity analysis, which is concerned primarily with traffic flows trough a schematically represented intersection and geometric design have previously been considered as separate design functions often performed by different people, the system 100 also provide an opportunity for better integration between these two aspects of intersection design.

While specific embodiments of the invention have been described and illustrated, such embodiments should be considered illustrative of the invention only and not as limiting the invention.

What is claimed is:

1. A method for generating a geometric layout of a traffic intersection, the method comprising:
receiving intersection capacity data, wherein receiving includes:
receiving an identification of a number of intersection legs associated with the traffic intersection;
receiving a lane designation designating a plurality of lanes for accommodating permitted vehicle movements between the intersection legs, each lane having at least one associated permitted vehicle movement; and
receiving lane width dimensions for accommodating an expected vehicular traffic volume associated with permitted vehicle movements on each of said plurality of lanes;
generating a geometric layout of the traffic intersection by:
receiving orientation data defining respective orientations of each of said intersection legs;
receiving intersection design criteria for designing the traffic intersection;
for each intersection leg, combining said lane width dimensions and said intersection design criteria to determine extents of a roadway segment corresponding to said intersection leg; and
applying said intersection design criteria to generate corner geometry connecting between said roadway segments;
generating display signals for causing said geometric layout of the intersection to be displayed on a computer display.

2. The method of claim 1 further comprising generating said intersection capacity data using an intersection capacity analysis system.

3. The method of claim 2 wherein generating said intersection capacity data comprises for each permitted movement:
receiving a designation of an expected proportion of different vehicles classified in accordance with vehicle size;
receiving an expected flow of vehicles of each classification as a function of time; and
generating a lane width dimension sufficient to accommodate said flow of vehicles.

4. The method of claim 1 wherein receiving said intersection capacity data comprises receiving intersection capacity data at an interface of an intersection design system.

5. The method of claim 1 wherein receiving said intersection capacity data comprises receiving a data file having fields encoded with values defining said intersection leg identification, lane designation, and lane width dimensions.

6. The method of claim 5 wherein receiving said data file comprises receiving an extensible markup language (XML) data file.

7. The method of claim 1 wherein receiving said lane designation comprises receiving data defining at least one of an approach lane and an exit lane for each of the at least two roadways.

8. The method of claim 7 wherein receiving said lane designation comprises receiving at least one turn designation associated with each of said approach lanes and said exit lanes, said turn designation defining said permitted vehicle movements along each of said lanes.

9. The method of claim 1 wherein receiving said intersection capacity data further comprises receiving speed data associated with each of said permitted vehicle movements, and wherein applying said intersection design criteria to generate said corner geometry comprises using a defined turning path criteria of said design criteria to generate a corner geometry for safely accommodating said vehicle speed along said lane.

10. The method of claim 1 further comprising:
generating said intersection capacity data using an intersection capacity analysis system;
generating an updated geometric layout in response to receiving operator input defining a change to the intersection;
generating updated intersection capacity data including revised data corresponding to said change; and
causing said interface to transmit said updated intersection capacity data back to said capacity analysis system.

11. The method of claim 1 wherein receiving said intersection design criteria comprises receiving an operator selection of a traffic intersection template for designing the traffic intersection.

12. The method of claim 1 wherein receiving said intersection design criteria comprises receiving an operator selection of an industry standard intersection design guideline for designing the traffic intersection.

13. The method of claim 1 wherein receiving said intersection design criteria comprises receiving data defining line-of-sight criteria for the traffic intersection.

14. The method of claim 1 wherein receiving said intersection design criteria comprises receiving a designation of a design vehicle for designing the traffic intersection and wherein applying said intersection design criteria to generate corner geometry comprises:
identifying at least one permitted vehicle movement that defines said corner geometry connecting between said roadway segments;
generating a turning path of said design vehicle along said identified permitted vehicle movement;
generating first vehicle extent locations associated with passage of said design vehicle along said at least one turning path; and
generating an outer edge of said intersection area, said outer edge being generally aligned with selected ones of said first vehicle extent locations.

15. The method of claim 1 wherein receiving said orientation data comprises receiving at least two reference lines defining respective orientations of said intersection legs.

16. The method of claim 15 wherein receiving said at least two reference lines comprises receiving a reference line extending in a direction aligned with an intended direction of traffic movement along a corresponding intersection leg and wherein combining said lane width dimensions and said intersection design criteria comprises offsetting said lane width dimensions from said reference line to determine said extents of said a roadway segment corresponding to said intersection leg.

17. The method of claim 16 further comprising offsetting said lane width dimensions to accommodate at least one of:
a median between lanes;
a clearance allowance between lanes;
a clearance allowance between an edge of the roadway section and a curb defining a physical extent of the roadway; and or a storage bay associated with a lane designated to permit turning of a vehicle.

18. The method of claim 1 wherein applying said intersection design criteria to generate said corner geometry comprises:
generating a swept path of a design between said roadway segments; and
using said swept path to generate said corner geometry.

19. The method of claim 18 wherein using said swept path to generate said corner geometry comprises generating a curve that generally conforms to said swept path.

20. The method of claim 19 wherein said curve comprises one of a simple curve, a 2-centered compound curve, and a 3-centered compound curve.

21. An apparatus for displaying a geometric layout of a traffic intersection, the apparatus comprising a processor circuit operably configured to:
receive intersection capacity data including:
an identification of a number of intersection legs associated with the traffic intersection;
a lane designation designating a plurality of lanes for accommodating permitted vehicle movements between the intersection legs, each lane having at least one associated permitted vehicle movement; and
lane width dimensions for accommodating an expected vehicular traffic volume associated with permitted vehicle movements on each of said plurality of lanes;
generate a geometric layout of the traffic intersection by:
receiving orientation data defining respective orientations of each of said intersection legs;
receiving intersection design criteria for designing the traffic intersection;
for each intersection leg, combining said lane width dimensions and said intersection design criteria to determine extents of a roadway segment corresponding to said intersection leg; and and
applying said intersection design criteria to generate corner geometry connecting between said roadway segments; and
generate display signals for causing said geometric layout of the intersection to be displayed on a computer display.

22. The apparatus of claim 21 wherein said processor circuit is operably configured to generate said intersection capacity data using an intersection capacity analysis system.

23. The apparatus of claim 22 wherein said processor circuit is operably configured to generate said intersection capacity data for each permitted movement by:
receiving a designation of an expected proportion of different vehicles classified in accordance with vehicle size;
receiving an expected flow of vehicles of each classification as a function of time; and
generating a lane width dimensions sufficient to accommodate said flow of vehicles.

24. The apparatus of claim 21 further comprising an intersection design system having an interface operably configured to receive said intersection capacity data.

25. The apparatus of claim 21 wherein said processor circuit is operably configured to receive said intersection capacity data by receiving a data file having fields encoded with values defining said intersection leg identification, lane designation, and lane width dimensions.

26. The apparatus of claim 25 wherein said data file comprises receiving an extensible markup language (XML) data file.

27. The apparatus of claim 21 wherein said lane designation comprises data defining at least one of an approach lane and an exit lane for each of the at least two roadways.

28. The apparatus of claim 27 wherein said lane designation comprises at least one turn designation associated with each of said approach lanes and said exit lanes, said turn designation defining said permitted vehicle movements along each of said lanes.

29. The apparatus of claim 21 wherein said intersection capacity data comprises speed data associated with each of said permitted vehicle movements, and said processor circuit is operably configured to apply said intersection design criteria to generate said corner geometry by using a defined turning path criteria of said design criteria to generate a corner geometry for safely accommodating said vehicle speed along said lane.

30. The apparatus of claim 21 wherein said processor circuit is operably configured to:
generate said intersection capacity data using an intersection capacity analysis system;
generate an updated geometric layout in response to receiving operator input defining a change to the intersection;
generate updated intersection capacity data including revised data corresponding to said change; and
cause said interface to transmit said updated intersection capacity data back to said capacity analysis system.

31. The apparatus of claim 21 wherein said processor circuit is operably configured to receive said intersection design criteria by receiving an operator selection of a traffic intersection template for designing the traffic intersection.

32. The apparatus of claim 21 wherein said processor circuit is operably configured to receive said intersection design criteria by receiving an operator selection of an industry standard intersection design guideline for designing the traffic intersection.

33. The apparatus of claim 21 wherein said processor circuit is operably configured to receive said intersection design criteria by receiving data defining line-of-sight criteria for the traffic intersection.

34. The apparatus of claim 21 wherein said processor circuit is operably configured to receive said intersection design criteria by receiving a designation of a design vehicle for designing the traffic intersection and to apply said intersection design criteria to generate corner geometry by:
identifying at least one permitted vehicle movement that defines said corner geometry connecting between said roadway segments;
generating a turning path of said design vehicle along said identified permitted vehicle movement;
generating first vehicle extent locations associated with passage of said design vehicle along said at least one turning path; and
generating an outer edge of said intersection area, said outer edge being generally aligned with selected ones of said first vehicle extent locations.

35. The apparatus of claim 21 wherein said processor circuit is operably configured to receive said orientation data by receiving at least two reference lines defining respective orientations of said intersection legs.

36. The apparatus of claim 35 wherein said processor circuit is operably configured to receive said at least two reference lines by receiving a reference line extending in a direction aligned with an intended direction of traffic movement along a corresponding intersection leg and to combine said lane width dimensions and said intersection design criteria by offsetting said lane width dimensions from said reference line to determine said extents of said a roadway segment corresponding to said intersection leg.

37. The apparatus of claim 36 wherein said processor circuit is operably configured to offset said lane width dimensions to accommodate at least one of:
a median between lanes;
a clearance allowance between lanes;
a clearance allowance between an edge of the roadway section and a curb defining a physical extent of the roadway; and or
a storage bay associated with a lane designated to permit turning of a vehicle.

38. The apparatus of claim 21 wherein said processor circuit is operably configured to apply said intersection design criteria to generate said corner geometry by:
generating a swept path of a design between said roadway segments; and
using said swept path to generate said corner geometry.

39. The apparatus of claim 38 wherein said processor circuit is operably configured to use said swept path to generate said corner geometry by generating a curve that generally conforms to said swept path.

40. The apparatus of claim 39 wherein said curve comprises one of a simple curve, a 2-centered compound curve, and a 3-centered compound curve.

41. A computer readable medium encoded with codes for directing a processor circuit to display a geometric layout of a traffic intersection, said codes directing the processor circuit to:
receive intersection capacity data including:
an identification of a number of intersection legs associated with the traffic intersection;
a lane designation designating a plurality of lanes for accommodating permitted vehicle movements between the intersection legs, each lane having at least one associated permitted vehicle movement; and
lane width dimensions for accommodating an expected vehicular traffic volume associated with permitted vehicle movements on each of said plurality of lanes;
generate a geometric layout of the traffic intersection by:
receiving orientation data defining respective orientations of each of said intersection legs;
receiving intersection design criteria for designing the traffic intersection;
for each intersection leg, combining said lane width dimensions and said intersection design criteria to determine extents of a roadway segment corresponding to said intersection leg; and
applying said intersection design criteria to generate corner geometry connecting between said roadway segments; and
generate display signals for causing said geometric layout of the intersection to be displayed on a computer display.
